(19) United States
(12) Patent Application Publication
(10) Pub. No.: US 2026/0222405 A1
(43) Pub. Date: Jul. 30, 2026

(54) BIOMETRIC INFORMATION MANAGEMENT DEVICE, BIOMETRIC INFORMATION MANAGEMENT SYSTEM, BIOMETRIC INFORMATION MANAGEMENT METHOD, AND STORAGE MEDIUM

(71) Applicant: CANON KABUSHIKI KAISHA, Tokyo (JP)

(72) Inventors: HIDEO NORO, Tokyo (JP); KUNIHIKO YAMAKAWA, Kanagawa (JP)

(21) Appl. No.: 19/455,607

(22) Filed: Jan. 21, 2026

(30) Foreign Application Priority Data
Jan. 28, 2025 (JP) 2025-012465

(51) Int. Cl. H04L 9/40; G06F 21/32

(52) U.S. Cl. CPC H04L 63/0861; G06F 21/32

(57) ABSTRACT

A biometric information management device stores biometric-related information involving biometric information and manages availability of the biometric information. The biometric information management device includes at least one memory storing instructions; and at least one processor executing the stored instructions causing the biometric information management device to perform: acquiring consent information for use of the biometric information received from an external device; storing and managing the biometric-related information and the consent information; returning, in response to a consent acquisition request for user of designated biometric information from the external device, response consent information indicating the availability of the biometric information to the external device having transmitted the consent acquisition request; and generating the response consent information on the basis of the consent acquisition request and the stored consent information.

### BACKGROUND

### Field of the Technology

The present disclosure relates to a biometric information management system that is suitable illustrate an intention of consent to use of biometric information of a person for whom biometric information has been registered and maintaining consent to use of biometric information under various conditions in a system performing authentication using biometric information.

### Description of the Related Art

With recent evolution in hardware technology and development in AI recognition technology, authentication techniques using biometric information such as face authentication have been widely put into practical use. For example, authentication techniques using biometric information are expected to be applied to various services such as a photo album service that prepare an album for each person from a plurality of images and a lost child search service using network cameras.

In order to efficiently provide such services, biometric information including, face images, iris images, or biometric identifiers, needs to be managed and used for identifying individuals extracted.

However, since biometric information is calculated from faces, irises, or fingerprints, it is difficult to change the biometric information. For example, when a personal identification card such as an insurance certificate is lost or leaked, a new number may be issued, but it is difficult to change biometric information associated therewith. Accordingly, there is a risk when such a personal identification card is lost or is leaked, and careful handling thereof is required to ensure protection of personal information. Because of this, there is a limitation on how to handle biometric information has been legislated in many countries or regions with protection of personal information in mind. Under these laws, acquisition, storage, use, and the like of biometric identifiers without getting consent from the individuals is prohibited, and a very high fine or indemnity may be set when it is violated. Accordingly, when a company uses a user's biometric information, it may be considered as an illegal act, and thus impacting business activities.

A system using biometric information where consent to use has been obtained is disclosed in Japanese Patent Laid-Open No. 2023-109134. In Japanese Patent Laid-Open No. 2023-109134, a technique of allowing a user to register identification information (such as a face image or a fingerprint image) in a management server in advance and providing information correlated with the identification information to a designated external service is disclosed.

In the technique described in Japanese Patent Laid-Open No. 2023-109134, an input of identification information including biometric information is received from a user, the identification information is registered, and a shared range thereof is permitted or the range is set (Paragraphs 0042 to 0046).

However, conditions when a user gives consent to authentication using biometric information are not unique, and a user may give consent in only predetermined conditions such as limited places or time periods or use for limited purposes. When consenting to authentication using biometric information in a plurality of devices or different time periods is registered in the system, confusion as to what conditions apply at what time or on what device may occur.

In this case, in an authentication system using biometric information according to the related art, consent to use biometric information for authentication under the predetermined conditions may not have been able to be given causing the system to believe that consent could not be given due to an error when different conditions to authenticate using biometric information occur. Accordingly, a problem results where it is difficult to realize consent to authentication using biometric information based on a user's intention.

### SUMMARY

The present disclosure is directed to provide a biometric information management system that can easily reflect an intention of consent to use of biometric information of a person for whom biometric information has been registered and maintain consistency of consent to use of biometric information under various conditions.

A biometric information management device according to an aspect of the present disclosure stores biometric-related information and manages availability of the biometric information. The biometric information management device includes at least one memory storing instructions; and at least one processor executing the stored instructions causing the biometric information management device to perform: acquiring consent information allowing use of the biometric information received from an external device; storing and managing, in the at least one memory, the biometric-related information and the consent information; generating, based on a consent acquisition request for use of designated biometric information from the external device, and the stored consent information, a consent information response indicating the availability of the biometric information; and returning the consent information response on the basis of the consent acquisition request to the external device which transmitted the consent acquisition request.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating the entire configuration of a biometric information management system.

FIG. 2 is a diagram illustrating a functional configuration of a biometric information management server.

FIG. 3 is a diagram illustrating a functional configuration of a camera according to a first embodiment.

FIG. 4 is a diagram illustrating a hardware configuration and a software configuration of the biometric information management server.

FIG. 5 is a diagram illustrating an example of a biometric-related information table according to the first embodiment.

FIG. 6 is a diagram illustrating an example of a biometric information use consent information table according to the first embodiment.

FIG. 7 is a diagram illustrating an example of a member information table.

FIG. 8 is a flowchart illustrating a process flow until consent information to use of biometric information is registered in the biometric information management server from the camera.

FIG. 9 is a flowchart illustrating a process flow from imaging in the camera to displaying an image.

FIG. 10 is a flowchart illustrating a process flow of causing the biometric information management server to respond when the camera according to the first embodiment has inquired about consent to use of biometric information.

FIG. 11 is a diagram illustrating an example in which a name of a person is superimposed and displayed on a screen of the camera.

FIG. 12 is a diagram illustrating another functional configuration of the camera according to the first embodiment.

FIG. 13 is a flowchart illustrating a process flow of causing a biometric information management server to respond when a camera according to a second embodiment has inquired about consent to use of biometric information.

FIG. 14 is a diagram illustrating an example of a biometric information use consent information table according to a third embodiment.

FIG. 15 is a flowchart illustrating a process flow that is performed by a consent mediating unit according to the third embodiment.

FIG. 16A is a diagram illustrating an example of a biometric information use consent information table according to a fourth embodiment.

FIG. 16B is a diagram illustrating an example of the biometric information use consent information table according to the fourth embodiment.

FIG. 17A is a chart illustrating a relationship between a time and permission/rejection of consent to use of a face feature for each record.

FIG. 17B is a chart illustrating the relationship between a time and permission/rejection of consent to use of a face feature for each record.

FIG. 18 is a diagram illustrating an example of a biometric information use consent information table according to a fifth embodiment.

FIG. 19A is a illustrating a geographical range.

FIG. 19B is a illustrating a geographical range.

FIG. 20A is a flowchart illustrating a process flow that is performed by a consent mediating unit according to a sixth embodiment.

FIG. 20B is a flowchart specifically illustrating a part of the process flow that is performed by the consent mediating unit according to the sixth embodiment.

FIG. 21 is a diagram illustrating an example of a biometric-related information table according to a seventh embodiment.

FIG. 22 is a flowchart illustrating a process flow of calculating a representative feature from a plurality of features.

FIG. 23 is a diagram illustrating a state of case classification in FIG. 20B.

### DESCRIPTION OF THE EMBODIMENTS

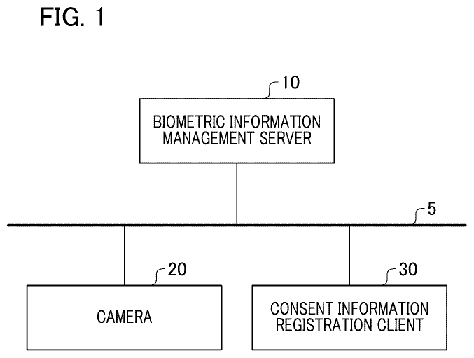

Hereinafter, embodiments of the present disclosure will be described with reference to FIGS. 1 to 23.

### First Embodiment

Hereinafter, a first embodiment of the present disclosure will be described with reference to FIGS. 1 to 11.

In the present embodiment, for example, a biometric information management system that manages a user's permission/rejection of consent to use of biometric information of a person appearing in a camera in a system using biometric information of a person appearing in a camera such as a face authentication system will be described.

A configuration of the biometric information management system will be first described with reference to FIGS. 1 to 4.

FIG. 1 is a diagram illustrating the entire configuration of the biometric information management system.

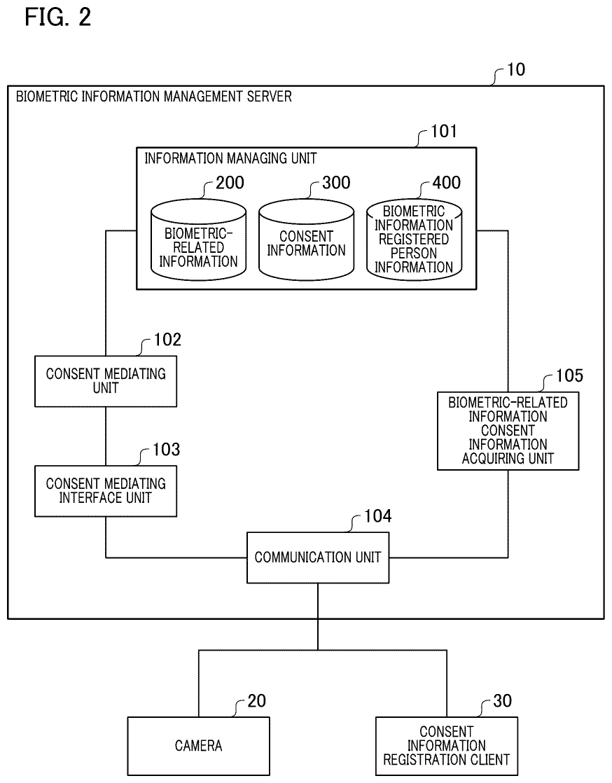

FIG. 2 is a diagram illustrating a functional configuration of a biometric information management server.

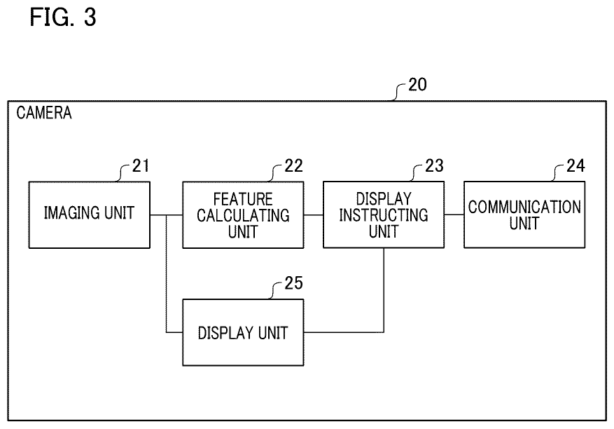

FIG. 3 is a diagram illustrating a functional configuration of a camera according to a first embodiment.

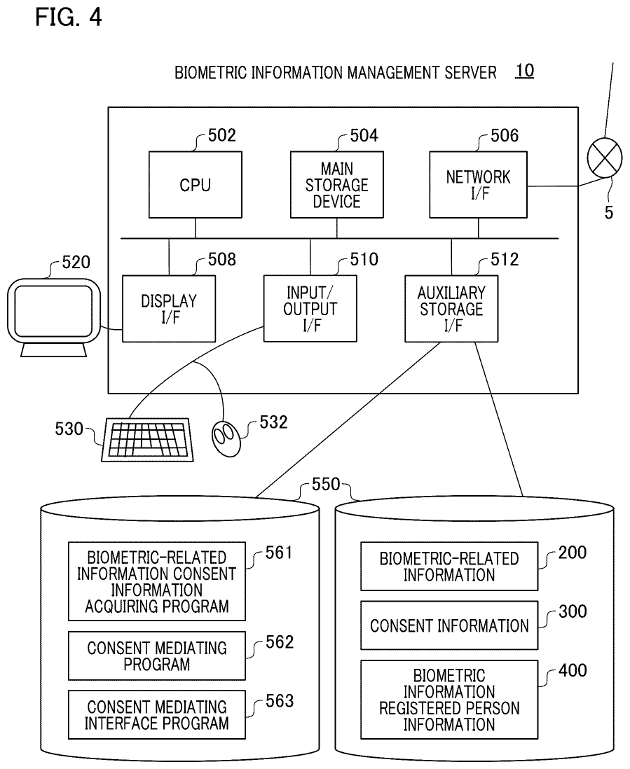

FIG. 4 is a diagram illustrating a hardware configuration and a software configuration of the biometric information management server.

The biometric information management system has a configuration in which a biometric information management server 10, a camera 20, and a consent information registration client 30 are communicatively connected to each other via a network 5 as illustrated in FIG. 1.

The biometric information management server 10 is a server that stores and manages biometric information of a user and provides the biometric information to an external system under a condition of the user's appropriate consent to use thereof.

The camera 20 is a device that images a user's shape which is handled as biometric information in the present embodiment and transmits data of a face image to the outside via the network 5. The camera 20 also has a function of a client that uses biometric information.

The consent information registration client 30 is a client terminal that registers information regarding consent to use of biometric information, use conditions, and the like.

The physical connection type of the network 5 may be wired or wireless. The network 5 may be a local area network (LAN) or may be a global network such as the Internet in its configuration.

The functional configuration of the biometric information management server will be described below with reference to FIG. 2.

The biometric information management server 10 includes an information managing unit 101, a consent mediating unit 102, a consent mediating interface unit 103, a communication unit 104, and a biometric-related information consent information acquiring unit 105 as functional units as illustrated in FIG. 2.

The biometric-related information consent information acquiring unit 105 is a functional unit that acquires biometric-related information 200 and consent information 300 transmitted from the consent information registration client 30 via the communication unit 104. Here, the biometric-related information 200 includes biometric information that from an organism and information indicating a type of a biometric information. Here, the biometric information may be primary biometric information which can be acquired directly from an organism such as a face image or secondary biometric information such as a feature which can be derived from the primary biometric information using a predetermined algorithm. In the present embodiment, when secondary biometric information is acquired as biometric information, it is assumed that a biometric information calculation algorithm type for identifying an algorithm used to derive second biometric information is included as biometric-related information. In the present embodiment, a face image is used as primary biometric information and a face feature vector is used as secondary biometric information, but the biometric information used in the present disclosure is not limited to a face and may be, for example, a fingerprint or an iris pattern.

It is assumed that the consent information 300 acquired by the biometric-related information consent information acquiring unit 105 includes a biometric information type of target biometric information, biometric information use conditions which are conditions for consent or non-consent, and consent permission/rejection information indicating whether to consent to use of biometric information when the biometric information use conditions are satisfied.

The information managing unit 101 is a functional unit that stores and manages relevant information such as the biometric-related information and the consent information acquired by the biometric-related information consent information acquiring unit 105.

The consent mediating interface unit 103 is a functional unit that performs pre-processing and post-processing of consent mediation in response to a consent acquisition request transmitted from the camera 20 when the biometric information is used via the communication unit 104 and returns response consent information and biometric information. Here, the consent acquisition request includes person identification information for uniquely identifying a person for whom biometric information has been registered in the biometric information management server 10 or person identification auxiliary information (which will be described later) capable of listing candidates for the registered person and further includes a biometric information type which is a type of biometric information to be returned to the camera 20. When the biometric information type is secondary biometric information, the consent acquisition request includes a biometric information calculation algorithm type which is a type of an algorithm for deriving secondary biometric information from the primary biometric information.

The consent mediating unit 102 is a functional unit that mediates an intention of consent of the person for whom biometric information has been registered on the basis of the consent acquisition request transmitted from the camera 20 and the consent information 300 stored in the information managing unit 101 and generates response consent information. Here, the response consent information includes consent permission/rejection and further includes person identification information and biometric information corresponding to the person identification information when consent is permitted.

The communication unit 104 is a functional unit that performs communication between the biometric information management server 10 and the camera 20 and the consent information registration client 30.

The functional configuration of the camera will be described below with reference to FIG. 3.

As illustrated in FIG. 3, the camera 20 includes an imaging unit 21, a feature calculating unit 22, a display instructing unit 23, a communication unit 24, and a display unit 25 as functional units.

The imaging unit 21 is a functional unit that receives light via a lens and forms an image. The feature calculating unit 22 is a functional unit that calculates particularly a feature of biometric information (a face image). The display instructing unit 23 is a functional unit that instructs to display information associated with biometric information, for example, a name of an imaged person. The communication unit 24 is a functional unit that communicates with the biometric information management server 10 which is an external device. The display unit 25 is a functional unit that displays a captured image or information associated therewith.

A hardware configuration and a software configuration of the biometric information management server 10 will be described below with reference to FIG. 4.

The hardware configuration of the biometric information management server 10 employs, for example, a configuration of a general server device illustrated in FIG. 4.

The biometric information management server 10 has a configuration in which a central processing unit (CPU) 502, a main storage device 504, a network I/F 506, a display I/F 508, an input/output I/F 510, and an auxiliary storage I/F 512 are coupled to each other via a bus.

The CPU 502 controls the constituent units of the biometric information management server 10 and loads and executes a necessary program to the main storage device 504.

The main storage device 504 is generally constituted by a volatile memory such as a RAM and stores a program executed by the CPU 502 and data referred to by the CPU 502.

The network I/F 506 is an interface for connection to the network 5.

The display I/F 508 is an interface for connection to a display device 520 such as a liquid crystal display (LCD).

The input/output I/F 510 is an interface for connection to an input/output device. In the example illustrated in FIG. 4, a keyboard 530 and a mouse 532 which is a pointing device are connected thereto.

The auxiliary storage I/F 512 is an interface for connection to an auxiliary storage device such as a hard disk drive (HDD) 550 or a digital versatile disk (DVD) drive.

The HDD 550 has a large storage capacity and stores programs for realizing the present embodiment. A biometric-related information consent information acquiring program 561, a consent mediating program 562, and a consent mediating interface program 563 are installed in the biometric information management server 10. The biometric-related information consent information acquiring program 561, the consent mediating program 562, and the consent mediating interface program 563 are computer programs for realizing the functions of the biometric-related information consent information acquiring unit 105, the consent mediating unit 102, and the consent mediating interface unit 103, respectively.

The HDD 550 stores biometric-related information 200, consent information 300, and biometric information registered person information 400.

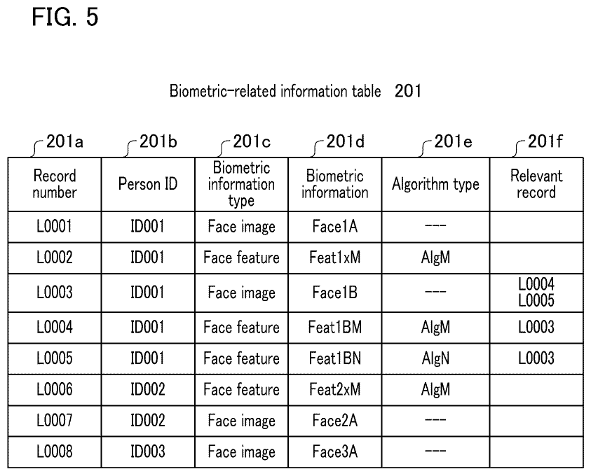

A data structure of data that is managed by the biometric information management server will be described below with reference to FIGS. 5 to 7.

FIG. 5 is a diagram illustrating an example of a biometric-related information table according to the first embodiment.

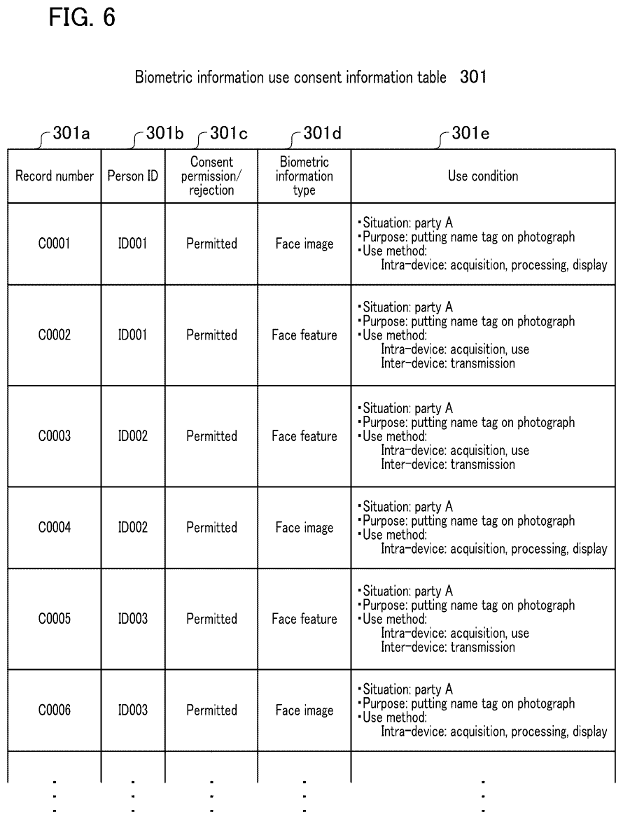

FIG. 6 is a diagram illustrating an example of a biometric information use consent information table according to the first embodiment.

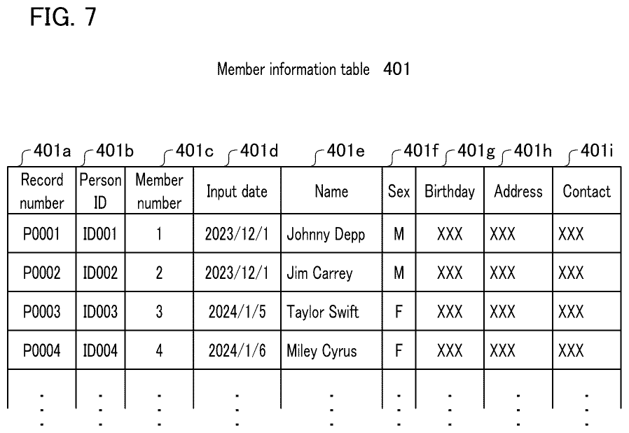

FIG. 7 is a diagram illustrating an example of a member information table.

A biometric-related information table 201 is a table in which biometric-related information 200 is stored. As illustrated in FIG. 5, the biometric-related information table 201 includes fields of record number 201a, person ID 201b, biometric information type 201c, biometric information ID 201d, algorithm type 201e, and relevant record 201f.

The record number 201a is a key to this table, and a number uniquely indicating a record is stored therein. An identifier uniquely indicating a person for whom biometric information has been registered is stored in the person ID 201b. The person ID 201b can employ, for example, member numbers or my numbers that are allocated to all people in Japan. A type of biometric information is stored in the biometric information type 201c. In the example illustrated in FIG. 5, a “face image” and a “face feature” obtained by analyzing the face image are shown as the type of biometric information. An identifier uniquely indicating biometric information is stored in the biometric information ID 201d. In the example of the biometric information ID 201d illustrated in FIG. 5, “FacePX” represents that the biometric information type is “face image,” P is a unit place of a person ID, and X is an ID indicating the face image. “FacePXY” represents that the biometric information type is “face feature,” P is a unit place of a person ID, X is an ID indicating the face image, and Y indicates a part of an ID indicating an algorithm. As illustrated in FIG. 5, a plurality of pieces of biometric information in which the biometric information type is “face image” and the biometric information type is “face feature” may be stored for each person. When the biometric information type is “face feature,” an identifier indicating an algorithm type when the face feature is extracted from the face image is stored in the algorithm type 201e. Here, the face feature is calculated from face image data using a predetermined algorithm. The predetermined algorithm herein is, for example, FaceNet which is an algorithm using deep learning. Here, FaceNet is an algorithm of optimizing an Euclidean distance between face feature vectors. When an algorithm using deep learning such as FaceNet is used, the algorithm is stored as a set along with a parameter called a weight. The values of the record numbers 201a of records relevant to the record are stored in the relevant record 201f. For example, the value of the record number 201a of the record storing the extracted face feature is stored when the biometric information type is “face image,” and the value of the record number 201a of the record storing the original face image is stored when the biometric information type is “face feature.” The face image or the face feature stored as biometric information may not be necessarily associated with the relevant record number. For example, in a record in which the record number 201a is “L0001” in FIG. 5, the biometric information type is “face image,” “Face1A” is stored in the biometric information ID 201d, but a face feature relevant thereto is not stored.

In the example of the present embodiment, it is assumed that the face image and the face feature are stored in the same table as the biometric-related information, but primary information of biometric information and a feature originating therefrom may be stored in different tables. The biometric information is stored in a table based on RDB, but the table may be realized by a database of another format, for example, a graph database which is a database with a graph structure.

A biometric information use consent information table 301 is a table in which the consent information 300 associated with use of the biometric information is stored. As illustrated in FIG. 6, the biometric information use consent information table 301 includes fields of record number 301a, person ID 301b, consent permission/rejection 301c, biometric information type 301d, and use condition 301e.

The record number 301a is a key to this table, and a number uniquely indicating a record is stored therein. An identifier uniquely indicating a person for whom biometric information has been registered is stored in the person ID 301b. A flag indicating in what use conditions consent to use of biometric information is gotten from a person of the corresponding person ID 301b is stored in the consent permission/rejection 301c. A type of biometric information associated with use is stored in the biometric information type 301d. In the present embodiment, two types including a “face image” and a “face feature” obtained by analyzing the face image are used as the types of biometric information. Conditions in which biometric information of the corresponding person is used for consent are stored in the use condition 301e. The value of the use condition 301e may be, for example, a use method in which biometric information is used, a user purpose, a use device, a use situation, or a relationship between persons appearing in the same image or may be a combination thereof.

A member information table 401 is a table indicating an example of the biometric information registered person information 400, and information on members in a certain community is stored therein. As illustrated in FIG. 7, the member information table 401 includes fields of a record number 401a, a person ID 401b, a member number 401c, payment date 401d, name 401e, sex 401f, birthday 401g, address 401h, and contact 401i.

The record number 401a is a key to this table, and a number uniquely indicating a record is stored therein. An identifier uniquely indicating a member is stored in the person ID 401b. This ID is the same as the person ID 201b in the biometric-related information table 201 illustrated in FIG. 5 and the person ID 301b in the biometric information use consent information table 301 illustrated in FIG. 6. A number uniquely allocated to each member in the community is stored in the member number 401c. A name, sex, a birthday, an address, and a contact of each member are stored in the name 401e, the sex 401f, the birthday 401g, the address 401h, and the contact 401i, respectively. The value of the contact 401i is, for example, a phone number of each member or an E-mail address of each member.

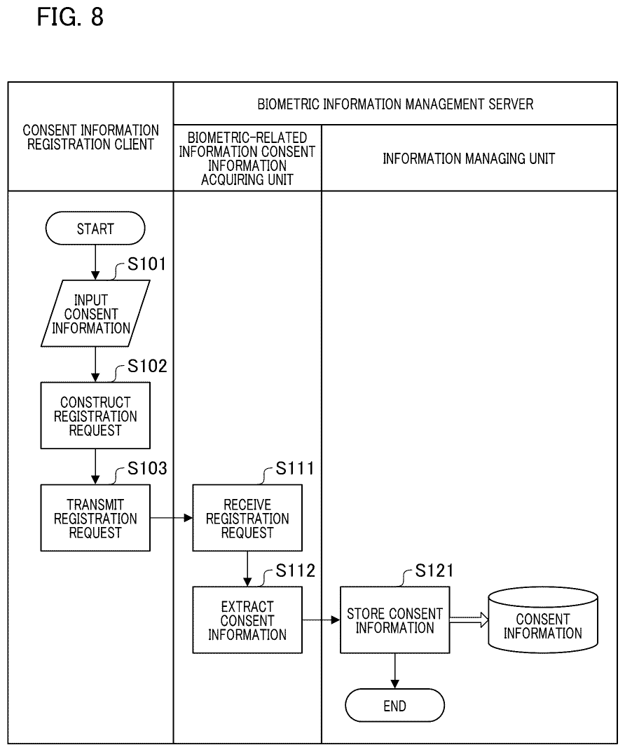

A process flow in the biometric information management system according to the first embodiment will be described below with reference to FIGS. 8 to 11.

FIG. 8 is a flowchart illustrating a process flow until consent information to use of biometric information is registered in the biometric information management server from the camera.

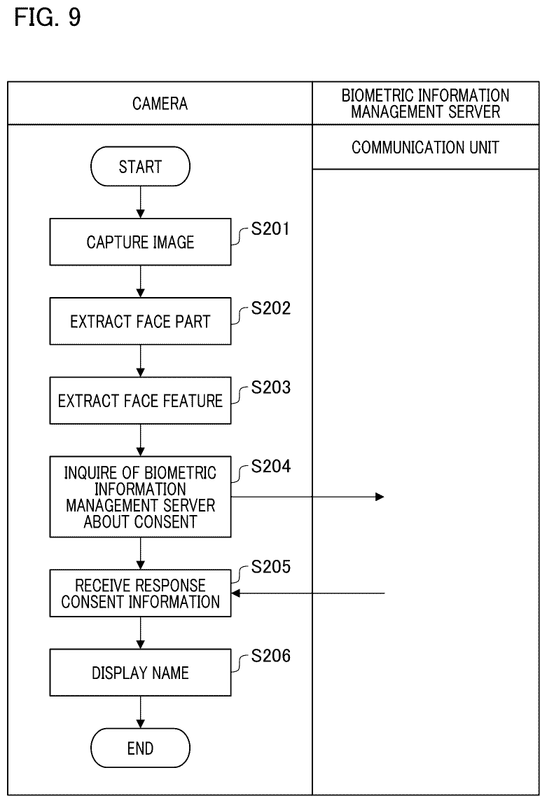

FIG. 9 is a flowchart illustrating a process flow from imaging in the camera to displaying an image.

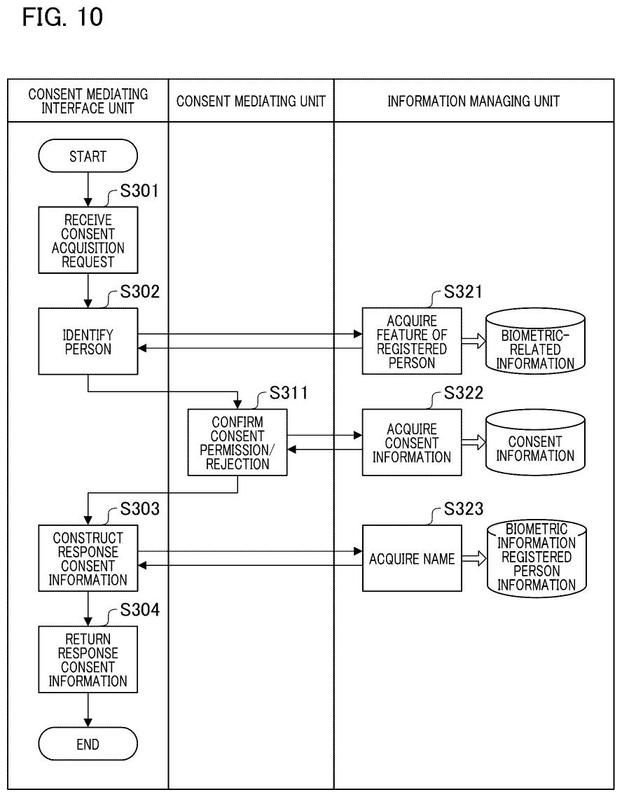

FIG. 10 is a flowchart illustrating a process flow of causing the biometric information management server to respond when the camera according to the first embodiment has inquired about consent to use of biometric information.

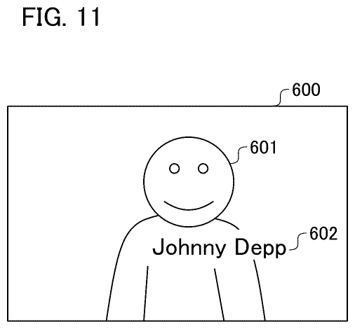

FIG. 11 is a diagram illustrating an example in which a name of a person is superimposed and displayed on the screen of the camera.

In the present embodiment, details of the process flow will be described with reference to an example in which names of persons appearing in an image are superimposed and displayed when a snapshot is taken using a camera carried by each member in a certain community in party A in which the members gather.

It is assumed that consent condition 1 and consent condition 2 described below are approved by all the members in the community as the premise.
Consent condition 1:
Each member consents to use of a face feature in order to confirm consent to use of biometric information.
Consent condition 2:
Each member in party A consents to capturing a face image.

Consent condition 1 is a consent condition required for identifying a person appearing in a captured image and is essential for using the biometric information management system according to the present embodiment.

The biometric information management system according to the present embodiment determines consent permission/rejection of a person appearing in the captured image and has difficulty determining that imaging is not performed before identifying a person. Accordingly, consent condition 2 is actually determined as a condition of operation or participation in party A for members participating in party A.

Since these two consent conditions are essential, consent condition 1 and consent condition 2 may be managed by the biometric information management server 10 even if details thereof are not mentioned.

A process flow of registering consent to use of a biometric feature of a person as a subject in the biometric information management server 10 will be first described with reference to FIG. 8.

Here, it is assumed that consent to consent condition 3 of a member in which a member number 401a in the member information table 401 illustrated in FIG. 7 is “1” is registered in the biometric information management server 10 using the consent information registration client 30.
Consent condition 3:
In party A (use situation)
Consent to (consent permission/rejection)
Putting a name tag on a photograph (purpose)

As will be described later, a face feature calculated from a face image is used to identify a person. Therefore, consent condition 3 can be divided into consent information 3-1 and consent information 3-2 in view of biometric information of a face image and a face feature.
Consent information 3-1:
For a person with an ID 001 (person ID)
In party A (use situation)
Consent to (consent permission/rejection)
Putting a name tag on a photograph (purpose)
By acquiring, processing, and displaying in a device (use method)
A face image (biometric information type)
Consent information 3-2:
For a person with an ID 001 (person ID)
In party A (use situation)
Consent to (consent permission/rejection)
Putting a name tag on a photograph (purpose)
By acquiring and using in a device and transmitting between devices (use method)
A face feature (biometric information type)

The consent information registration client 30 requests registration by transmitting consent information 3-1 and consent information 3-2 to the biometric information management server 10 via the network 5. The consent information registration client 30 may cause a user to input consent condition 3 and cause a program to divide consent condition into consent information 3-1 and consent information 3-2 or may cause a user to directly input consent information 3-1 and consent information 3-2.

The process flow until the consent information registration client 30 transmits a registration request of consent information 3 to the biometric information management server 10 and consent information 3 is registered will be described below with reference to FIG. 8.

A user inputs consent information 3 to the consent information registration client 30 (S101).

Then, the consent information registration client 30 divides consent information 3 into consent information 3-1 and consent information 3-2 and constructs data of a registration request as a command (S102).

Then, the consent information registration client 30 transmits the registration request to the biometric information management server 10 via the network 5 (S103).

Then, the biometric-related information consent information acquiring unit 105 of the biometric information management server 10 receives the registration request (S111) and extracts consent information 3-1 and consent information 3-2 from the registration request (S112).

Then, the information managing unit 101 of the biometric information management server 10 gives a record number capable of uniquely identifying a record in the biometric information use consent information table 301 illustrated in FIG. 6 to consent information 3-1 and consent information 3-2 and stores the resultant information (S121).

In the biometric information use consent information table 301 illustrated in FIG. 6, the value of the record number 301a corresponding to consent information 3-1 is “C0001,” and the value of the record number 301a corresponding to consent information 3-2 is “C0002.”

When a face image or biometric-related information such as a face feature is registered in the biometric information management server 10, targets to be registered are different, but the process is almost the same as the process flow illustrated in FIG. 8 by replacing the consent information with the biometric-related information.

The face image may be an image captured by a user in that place, or an image captured in advance may be used.

Here, “L0001” of the record number 201a in FIG. 5 is a record in which a person with “ID001” of the person ID 201b has registered “Face1A” of the biometric information ID 201d of the face image. “L0002” of the record number 201a in FIG. 5 is a record in which a person with “ID001” of the person ID 201b has registered “Feat1xM” of the biometric information ID 201d of the face feature calculated using an algorithm with “A1gM” of the algorithm type 201a.

As described above, by causing persons participating in party A to sequentially perform an operation of registering the face image, the face feature, and the consent information, the face image, the face feature, and the consent information based on an intention of each participant in party A are accumulated in the information managing unit 101 of the biometric information management server 10.

The process flow from imaging with a camera to displaying the image will be described below with reference to FIGS. 8 and 9.

Here, it is assumed that a live-view liquid crystal screen is provided in the camera 20. When a person is captured in a frame, it is assumed that an application of superimposing and displaying a name 602 of the person on a person image 601 on the live-view liquid crystal screen 600 is realized as illustrated in FIG. 11 only when the person consents thereto.

First, the imaging unit 21 of the camera 20 captures an image including a person (S201).

Then, the feature calculating unit 22 of the camera extracts a face part (detects a face) from the captured image (S202) and extracts a feature (extract a face feature) (S203). The face detecting technique is a basic technique for identifying a position of a face in an image or a video, and, for example, RetinalFace can be used. RetinaFace is a face detecting technique with high precision based on FPN and ResNet and is an algorithm with high robustness to illumination conditions, a face direction, and blocking. The face feature extraction is the same as described above, and it is assumed that “A1gM” illustrated in FIG. 5 is used as a predetermined technique.

Then, the display instructing unit 23 of the camera 20 inquires of the biometric information management server 10 about whether to use biometric information via the communication unit 24 using consent acquisition request 1 described below (S204).
Consent acquisition request 1:
Person identification information:
   The face feature calculated by the feature calculating unit 22
Use situation:
   Party A (situation)
   Putting a name tag on a photograph (purpose)
   Face feature (biometric information type)
   Acquisition and use in a device and transmission between devices (use method)

Here, the person identification information is person identification information capable of uniquely a registered person in the biometric information management server 10 and is herein a face feature calculated by the feature calculating unit 22. When a face feature of a registered person (a face feature calculated using the same algorithm as in the feature calculating unit 22) can be acquired, the biometric information management server 10 can identify a registered person by performing comparison in the face feature.

When the person identification information is a face feature, the algorithm used to calculate the face feature needs to be identified, and it is assumed that that algorithm is shared by the biometric information management server 10 and the camera or that information is included in the person identification information. Here, it is assumed that the algorithm is “A1gM.”

Then, the display instructing unit 23 of the camera receives response consent information from the biometric information management server 10 (S205) and displays a name acquired using biometric information by the biometric information management server 10 when consent is permitted (S206). Specifically, when a detected person consents to superimposition and display of a name, the name of the person is acquired, and the display instructing unit 23 instructs the display unit 25 to superimpose and display the name on the captured image. In this way, as illustrated in FIG. 11, the name 602 (Johnny Depp) of the person is superimposed and displayed on the person image 601 on the live-view liquid crystal screen 600.

When consent has not been confirmed, that is, when “rejected” has been returned as the consent permission/rejection, superimposition and display of the name are not performed.

The response consent information will be described below.

The biometric information management server 10 checks whether a person suitable for the condition of consent acquisition request 1 has been registered, generates response consent information 1 corresponding to consent acquisition request 1, and returns response consent information 1 to the camera 20. Details of the operation of the biometric information management server 10 will be described later.
Response consent information 1:
Consent permission/rejection:
   Permitted
Other information:
   Johnny Depp (name of consenting person)

The consent permission/rejection in response consent information 1 represents whether consent matching the condition of consent acquisition request 1 has been gotten.

Here, since the consent permission/rejection is “permitted,” it can be confirmed that the person identified by the person identification information consents to use of biometric information (a face feature) designated by the biometric information type in a situation designated by the use situation.

When the consent permission/rejection is “permitted,” other information on the consenting person may be returned together. Here, the name of the consenting person is returned and is added as necessary information to the response by the consent mediating unit 102 because the use situation of consent acquisition request 1 includes “putting a name tag on a photograph.”

The information on the name may not be necessarily returned by the biometric information management server 10. For example, the person ID (ID001) may be returned instead of the name. The camera 20 may acquire the name by inquiring of another server (not illustrated) managing person attributes bout the name of the person ID.

The process flow of causing the biometric information management server to respond when the camera has inquired about consent to use of biometric information will be described below with reference to FIG. 10.

First, the consent mediating interface unit 103 of the biometric information management server 10 receives consent acquisition request 1 from the camera 20 via the communication unit 104 (S301).

Then, the consent mediating interface unit 103 identifies a person indicated by the person identification information (a face feature) from the received consent acquisition request 1 (S302). In this case, the face feature of a registered person (calculated by A1gM) can be acquired from the biometric-related information table 201 illustrated in FIG. 5 and comparison between the features can be performed.

Specifically, the information managing unit 101 extracts a record in which the biometric information type 201c is “face feature” and the algorithm type 201e is “A1gM” out of the records in the biometric-related information table 201 illustrated in FIG. 5 (S321).

In S302, the consent mediating interface unit 103 sequentially compares the person identification information (the face feature) of consent acquisition request 1 with the biometric information of the extracted record. In the example illustrated in FIG. 5, the values of the biometric information 201d of the records in which the value of the record number 201a is “L0002,” “L0004,” “L0006,” . . . are compared with the person identification information (the face feature) of consent acquisition request 1.

A similarity which is an index indicating whether the features are similar to each other is used for this comparison. The similarity calculation method is determined for each algorithm used for the feature extraction, and, for example, an Euclidean distance, a cosine similarity, or the like are often used.

Here, for example, it is assumed that the person identification information (the face feature) of consent acquisition request 1 is determined to have a high similarity to the biometric information with “Feat1xM” of the biometric information ID 201d in the record in which the record number 201a is “L0002.” At this time, the person indicated by the person identification information of consent acquisition request 1 is determined to be a person for whom the person ID is “ID001.”

Then, the consent mediating interface unit 103 requests the consent mediating unit 102 to confirm whether the identified person (with ID001) has permitted consent.

Accordingly, the consent mediating unit 102 checks whether the person with “ID001” of the person ID has permitted consent in the use situation of consent acquisition request 1 (S311).

In the process of S311, first, the consent mediating unit 102 requests the information managing unit 101 to extract a record in which the person ID 301b is “ID001” out of the records in the biometric information use consent information table 301 illustrated in FIG. 6 (S322).

In the example illustrated in FIG. 6, the records in which the record number 301a is “C0001” and “C0002” are extracted.

Then, in the process of S311, the conditions in the use situation of consent acquisition request 1 are compared with details of the records.

First, the biometric information type of consent acquisition request 1 is compared with the value of the biometric information type 301d of each record. In this example, since the value of the biometric information type 301d in which the record number 301a is “C0002” is “face feature,” this record is left as a candidate.

In comparison of other conditions such as a situation and a purpose, it is confirmed that the record in which the record number 301a is “C0002” satisfies all the conditions. Since the value of the consent permission/rejection 301c in which the record number 301a is “C0002” is “permitted,” the consent mediating unit 102 determines that “consent” is permitted in response to consent acquisition request 1.

When it is determined as in this example that consent is permitted, the consent mediating interface unit 103 constructs response consent information (S303). Here, data of response consent information 1 is constructed.

In this example, the consent mediating interface unit 103 analyzes “putting a name tag on a photograph” in the use situation of consent acquisition request 1 and requests the information managing unit 101 to return the name of the person attributes in the member information table 401 illustrated in FIG. 7. Then, the information managing unit 101 extracts a record (P0001) in which the person ID 401b is “ID001” out of the records in the member information table 401 and returns the value of the name 401e (S323). Here, “Johnny Depp” is returned. The consent mediating interface unit 103 constructs response consent information 1 from such information.

Then, the consent mediating interface unit 103 returns the constructed response consent information 1 to the camera 20 via the communication unit 104 (S304).

As described above, it is possible to make biometric information available when a corresponding person has permitted consent in response to a use request for the biometric information requested by the camera 20 on the basis of the consent conditions managed by the biometric information management server 10.

### Variation of First Embodiment

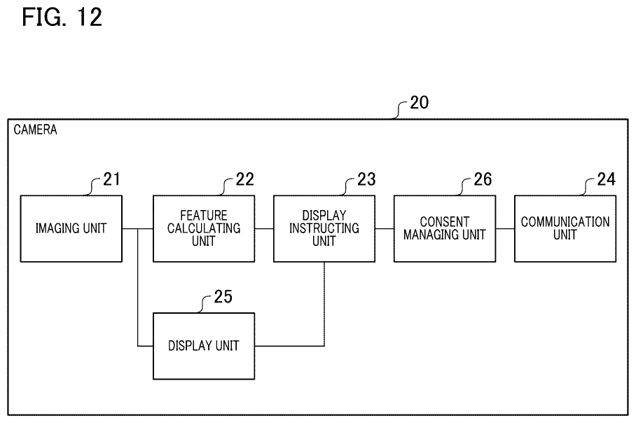

Another example of the system configuration according to a first embodiment will be described below with reference to FIG. 12.

FIG. 12 is another diagram illustrating the functional configuration of the camera according to the first embodiment.

In the system configuration according to the first embodiment, the biometric information management server 10, the consent information registration client 30, and the camera 20 are separate devices and are connected to each other via the network 5.

However, the camera 20 and the consent information registration client 30 may be different devices, and the functions thereof may be included, for example, in one smartphone.

They are not necessarily connected via a physical network and may be connected to each other via a system bus when they are provided in the same housing. When the constituent units are software components, the software components communicate with each other.

That is, one or both of the devices using biometric information such as the biometric information management server 10, the consent information registration client 30, and the camera 20 may be the same device.

For example, when the biometric information management server 10 is mounted as a software component or a hardware component in the camera 20 in the same device, the functional configuration of the camera 20 is the same as illustrated in FIG. 12. This functional configuration is different from the functional configuration illustrated in FIG. 3 in that a consent managing unit 26 is provided between the display instructing unit 23 and the communication unit 24.

In this case, communication between the display instructing unit 23 and the consent managing unit 26 is communication between internal components.

### Second Embodiment

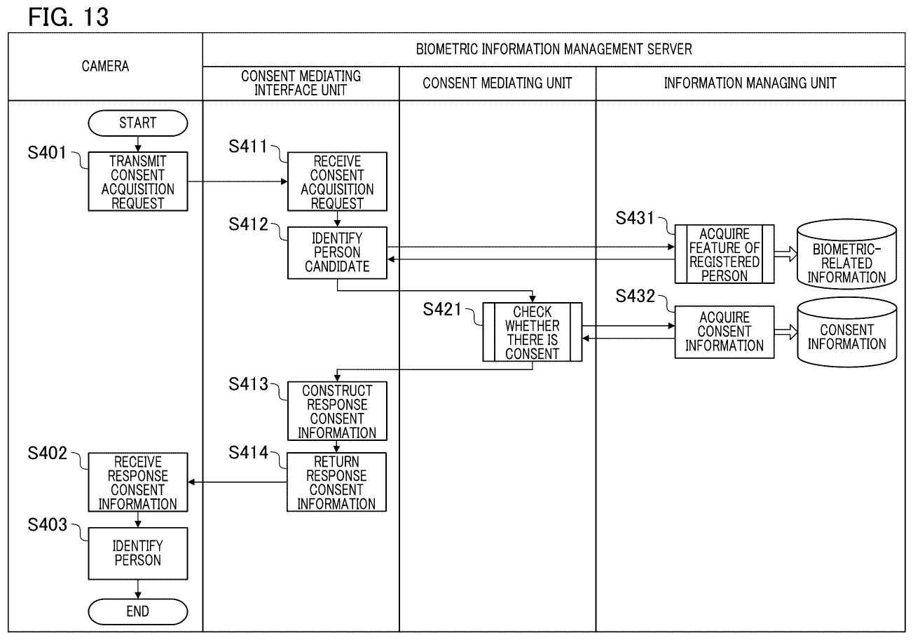

A second embodiment of the present disclosure will be described below with reference to FIG. 13.

FIG. 13 is a flowchart illustrating a process flow of causing the biometric information management server to respond when the camera according to the second embodiment has inquired about consent to use of biometric information.

In the first embodiment, a face feature is sent from the camera to the biometric information management server at the time of request for use of biometric information, and the biometric information management server performs identification.

In this case, when a person other than participants appears in the captured image, a face feature of the imaged person other than the participants is sent from the camera to the biometric information management server.

In the present embodiment, an example in which person identification auxiliary information for listing person candidates instead of person identification information (a face feature) capable of identifying a person is used for a request for use of biometric information will be described.

This is because transmission of a face feature of a person for whom consent has not been gotten between devices (between the server and the client) should be avoided. For this purpose, face features of persons for whom consent has been gotten can be sent from the biometric information management server 10 to the camera 20, and the camera 20 can perform identification. In this case, the idea of the present embodiment is that the consent acquisition request to be sent from the camera 20 to the biometric information management server 10 includes the person identification auxiliary information capable of listing a plurality of person candidates instead of the person identification information (features) capable of uniquely identifying persons.

For example, when a feature is a vector of 1024 dimensions, a vector of predetermined 768 dimensions or 512 dimensions taken therefrom can be set as the person identification auxiliary information. By employing information obtained by processing a feature in this way, the feature cannot be directly used for personal identification, and thus it is possible to reduce a risk of identifying an individual due to leakage and to protect privacy. Since an amount of data is reduced, there is also an advantage that an amount of communication data and an amount of calculation load in the server are reduced.

The process flow of causing the biometric information management server to respond when person identification auxiliary information is used and the camera has inquired about consent to use of biometric information will be described below with reference to FIG. 13.

Here, the camera 20 sends a consent acquisition request to the biometric information management server 10 in S401. The consent acquisition request at this time is, for example, the same as consent acquisition request 2.
Consent acquisition request 2:
Person identification auxiliary information:
   Person identification auxiliary information of a person appearing in a captured image
Biometric information type:
   Face feature
Biometric information calculation algorithm type:
   A1gM
Use situation:
   Party A (situation)
   Putting a name tag on a photograph (purpose)
   Face feature (biometric information type)
   Acquisition and use in a device and transmission between devices (use method)

The consent acquisition request 2 is different from the consent acquisition request 1 described in the first embodiment in that person identification information is replaced with person identification auxiliary information and a biometric information type and a biometric information calculation algorithm type are added.

The person identification auxiliary information is information capable of listing a plurality of person candidates as described above. The biometric information type is a type of biometric information to be included in a response to the consent acquisition request. Here, since the camera 20 identifies a person for whom consent cannot be confirmed, a face feature of a person candidate is to be included in the response. As described above, the face feature is secondary biometric information, and an algorithm (A1gM) for calculating the face feature from primary biometric information (a face image) is designated as the biometric information calculation algorithm type.

As will be described later, the biometric information management server 10 lists person candidates on the basis of information of consent acquisition request 2, adds biometric information (a face feature) of each person to the response consent information, and returns the response consent information. The response consent information received from the biometric information management server 10 by the camera 20 is, for example, the same as following response consent information 2.
Response consent information 2:
Consent permission/rejection:
   Permitted
Candidate (1)
   Biometric information:
      Feat1xM
   Person identification information
      ID001
Candidate (2)
   Biometric information:
      Feat2xM
   Person identification information
      ID002

As described above, response consent information 2 includes biometric information (a face feature) of candidates in addition to consent permission/rejection (permitted). Here, the person ID (person identification information) is further included therein, and this is for acquiring a name of the identified person. Accordingly, a name may be included instead of person identification information.

Then, the consent mediating interface unit 103 of the biometric information management server 10 receives consent acquisition request 2 from the camera 20 (S411).

Then, the consent mediating interface unit 103 identifies a person candidate from the person identification auxiliary information included in the received consent acquisition request 2 (S412).

Here, first, the information managing unit 101 extracts a record in which the biometric information type 201c is “face feature” and the algorithm type 201e is “A1gM” out of the records in the biometric-related information table 201 illustrated in FIG. 5 (S431).

In S412, the consent mediating interface unit 103 sequentially compares the person identification auxiliary information with the biometric information (face features) of the records and identifies candidates.

This comparison method can be performed as follows, for example, when predetermined 768 dimensions of a face feature of 1024 dimensions are extracted and used as the person identification auxiliary information.

First, predetermined 768 dimensions are extracted from the biometric information (face features) of the record acquired in S431, and the person identification auxiliary information is calculated. Then, a similarity to the person identification auxiliary information is calculated. When the similarity is equal to or greater than a predetermined value, that person is selected as a candidate.

Since a candidate is identified in S412, the consent mediating unit 102 confirms whether the candidate has consented (S421). This process is repeating the process of S311 in the first embodiment by the number of candidates.

Then, the consent mediating interface unit 103 constructs response consent information 2 from the biometric information and the person identification information of a person for whom the consent permission/rejection is determined to be “permitted” (S413).

When there is no candidate in S412 or when there is no person for whom the consent permission/rejection is “permitted” in S421, the consent permission/rejection can be set to “rejected” and the response consent information can be constructed.

Then, the consent mediating interface unit 103 returns the response consent information 2 constructed in S413 to the camera 20 as a response (S414).

Then, the camera 20 receives response consent information 2 from the biometric information management server 10 (S402).

Then, the camera 20 identifies a person for whom biometric information is to be used from response consent information 2 (S403). That is, response consent information 2 includes two candidates of candidate (1) and candidate (2), and a person appearing in the captured image is determined to be a person with a highest similarity by comparing the face feature of the candidate with the face feature of the person appearing in the captured image.

Since a person has been identified, the camera 20 superimposes and displays the name of the person acquired using the biometric information by the biometric information management server 10 on the captured image as illustrated in FIG. 11 similarly to S206 of FIG. 9 according to the first embodiment.

According to the present embodiment, as described above, data obtained by extracting some dimensions of the feature (for example, 768 dimensions or 512 dimensions out of 1024 dimensions) is used instead of a full feature as the person identification auxiliary information to be transmitted to the biometric information management server 10. With this configuration, it is possible to reduce a data size, to avoid transmission of information capable of directly identifying a person, and to protect privacy.

As a result, it is possible to check whether there is consent to use of biometric information without transmitting a face feature of a person having not consented to use of biometric information (transmission of a face feature between devices) between devices.

### Third Embodiment

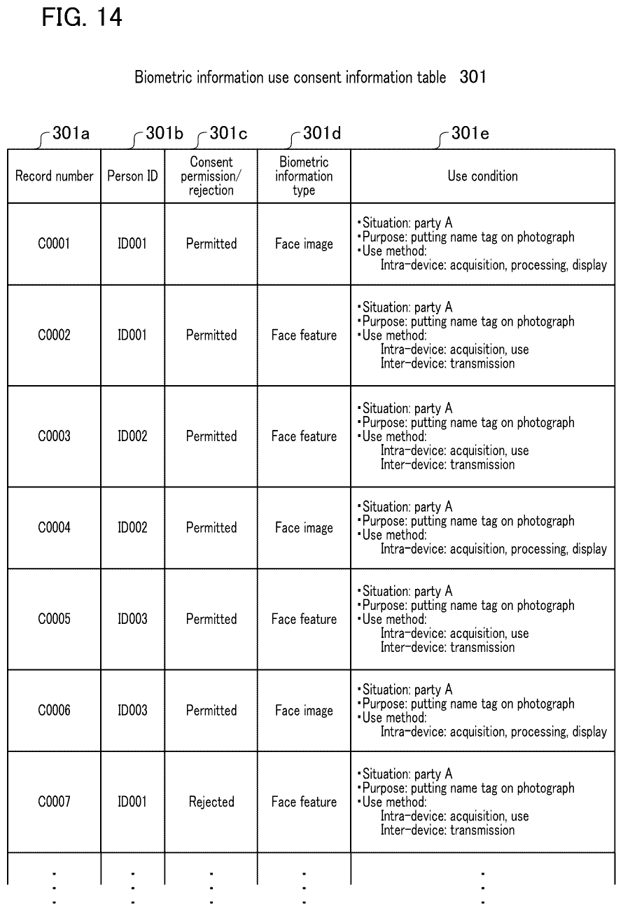

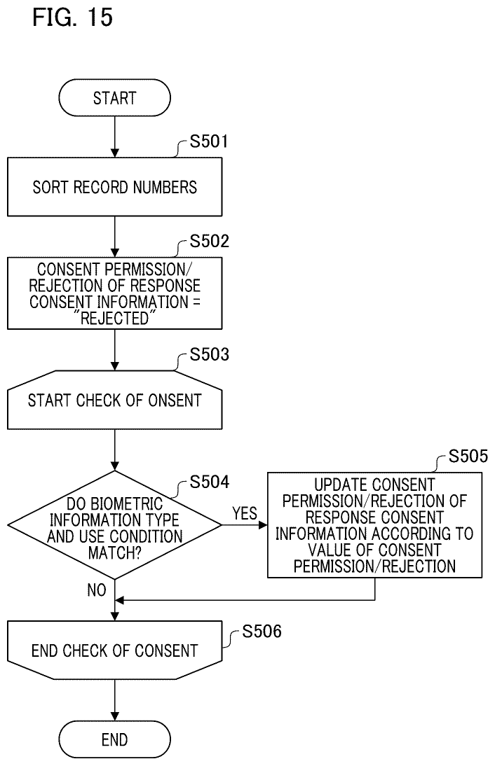

A third embodiment of the present disclosure will be described below with reference to FIGS. 14 and 15.

FIG. 14 is a diagram illustrating an example of a biometric information use consent information table according to the third embodiment.

FIG. 15 is a flowchart illustrating a process flow that is performed by a consent mediating unit according to the third embodiment.

In the first embodiment and the second embodiment, use conditions associated with biometric information indicated by the biometric information use consent information table do not collide with each other. Here, collision means a situation in which a plurality of use conditions include contradictory or conflicting details and thus it is difficult to simultaneously satisfy the use conditions. In the present embodiment, a method of performing mediation therebetween and acquiring a use condition desired by a registered person when two or more use conditions associated with biometric information collide with each other will be described.

In the first embodiment and the second embodiment, for example, it is assumed that a user wants to revoke consent in a state in which consent information 3-2 has been registered. In this case, even when following consent information 3-3 in which the consent permission/rejection in consent information 3-2 is changed to “rejected” is registered and consent information 3-2 is not deleted, there is a likelihood that the consent mediating unit 102 may select consent information 3-2 and determine that consent to use of biometric information (face feature) has been permitted.
Consent information 3-3:
For a person with an ID 001 (person ID)
In party A (use situation)
Putting a name tag on a photograph (purpose)
Face feature (biometric information type)
By acquiring, processing, and displaying in a device (use method)
Consent has been rejected (consent permission/rejection)

Therefore, the consent mediating unit 102 sequentially evaluates records from the record of which a registration time is the oldest at the time of check of consent permission/rejection and gives priority to the newest record.

For example, when the biometric information use consent information table 301 stored in the information managing unit 101 is the same as illustrated in FIG. 6 and consent information 3-3 is registered, the biometric information use consent information table 301 stored in the information managing unit 101 is the same as illustrated in FIG. 14.

That is, a record corresponding to consent information 3-3 in which the record number 301a is “C0007” is added.

Here, in order to confirm consent in consideration of a registration time, a field of registration time can be newly provided in the biometric information use consent information table 301, and that time can be stored at the time of new preparation of records. When the field of registration time is not provided, the order of registration times can be seen on the basis of the magnitudes of the record numbers by allocating the record numbers in the order of registration.

Here, when the consent permission/rejection has been confirmed similarly to the second embodiment, the consent mediating unit 102 confirms the consent permission/rejection in consideration of the registration time of consent information in S421 of FIG. 13.

In this example, the information managing unit 101 extracts a record in which the person ID 301b is “ID001” in S432 of FIG. 13. Three records in which the value of the record number 301a is “C0001,” “C0002,” and “C0007” are extracted.

The process of confirming consent permission/rejection in the consent mediating unit 102 according to the present embodiment will be described below in detail with reference to FIG. 15.

First, the consent mediating unit 102 of the biometric information management server 10 sorts the records in the order from the oldest to the newest with reference to the record numbers 301a in the biometric information use consent information table 301 (S501). This process is to sort the record numbers in the ascending order when a rule of allocating the record numbers in the order of registration is employed.

In the example illustrated in FIG. 14, as the result of the process of S501, the values of the record number 301a are sorted in the order of records “C0001,” “C0002,” and “C0007.”

Then, the consent mediating unit 102 sequentially confirms consent for the records (S503 and S506).

First, prior to S503 and S506, the consent permission/rejection of the response consent information is initialized to “rejected” (S502). This is because consent to use of biometric information needs to explicitly express “permitted” and a response indicating that consent has been “rejected” is returned when nothing is expressed.

Then, when the conditions of the consent acquisition request match the values of the biometric information type 301d and the use condition 301e in the biometric information use consent information table 301 (S504: YES), the consent permission/rejection of the response consent information is updated according to the value of the consent permission/rejection 301c (S505).

When the values of the biometric information type 301d and the use condition 301e in the biometric information use consent information table 301 do not match (S504: NO), the process flow transitions to processing a next record.

In the example illustrated in FIG. 14, first, a record in which the record number 301a is “C0001” is checked. In the record in which the record number 301a is “C0001,” the value of the biometric information type 301d is “face image,” and the biometric information type in the use situation of consent acquisition request 1 is a face feature. Accordingly, the conditions do not match (S504: NO). Accordingly, the consent permission/rejection of the response consent information is not changed. That is, the consent permission/rejection of the response consent information is maintained at “rejected.”

Then, a record in which the record number 301a is “C0002” is checked. In the record in which the record number 301a is “C0002,” the conditions of consent acquisition request 1 matches the values of the biometric information type 301d and the use condition 301e (S504: YES). Therefore, since the value of the consent permission/rejection 301c is “permitted,” the consent permission/rejection of the response consent information is set to “permitted” (S505).

Finally, a record in which the record number 301a is “C0007” is checked. In the record in which the record number 301a is “C0007,” the conditions match (S504: YES). Therefore, since the value of the consent permission/rejection 301c is “rejected,” the consent permission/rejection of the response consent information is set to “rejected” (S505).

Accordingly, the value of the consent permission/rejection 301c of a record registered at the latest time out of the records in which the conditions in the biometric information use consent information table 301 match has priority.

An example in which the consent mediating unit 102 sequentially evaluates the records from the record with the oldest registration time at the time of confirmation of the consent permission/rejection and gives priority to the newest record.

The record of the consent information to which the consent mediating unit 102 gives priority is not necessarily the newest record. For example, it is assumed that consent information “consent is rejected in Tokyo” is registered after consent information “consent is permitted in Tokyo Sky Tree Town” has been registered. In this case, “Tokyo Sky Tree Town” is a more specific and detailed range than “Tokyo,” and it may be determined that “consent is permitted in Tokyo Sky Tree Town but consent is rejected Tokyo other than Tokyo Sky Tree Town.”

That is, a record of consent information which is more specific and detailed has priority.

In this case, a record which has been registered later is evaluated earlier, and which has priority depends on a situation in which the consent mediating unit 102 is used. For example, the following design rule is conceivable, but the present disclosure is not limited thereto.
Priority is given to a record of which a registration time is later.
Priority is given to a record in a situation in which the use condition is more specific and detailed.
Priority is given to a record in a situation in which the use condition is more specific and detailed, and priority is given to a record of which a registration time is later when two or more records are specific and detailed to the same extent.
Priority is given to a record with a geographical range with a smaller area when the use condition includes geographical ranges, one is included in the other, and an area ratio is n times or more (for example, n=100).

### Fourth Embodiment

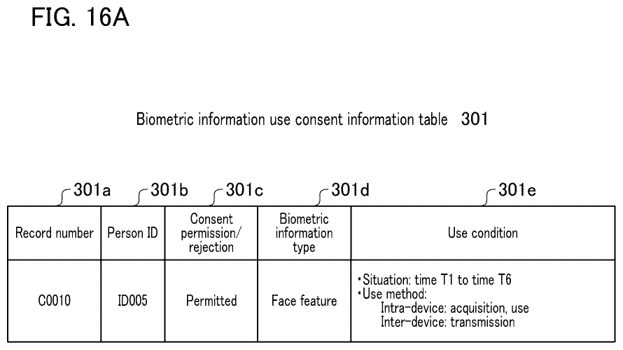

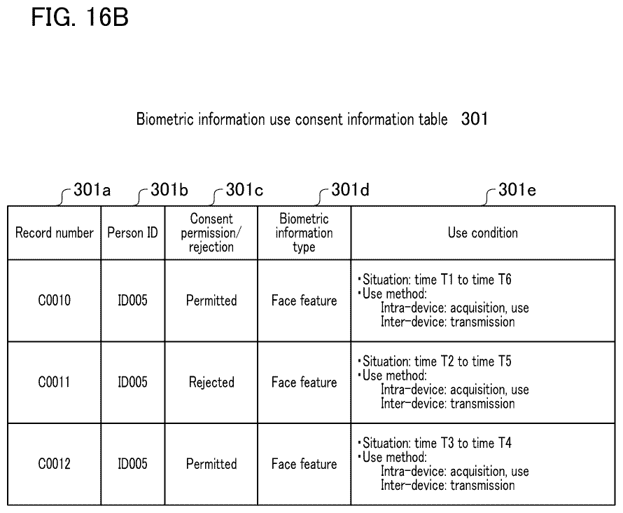

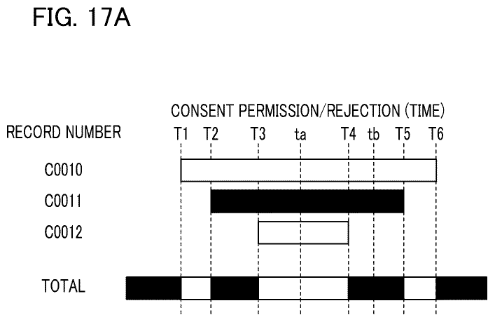

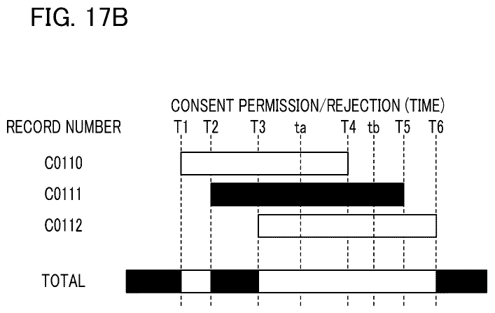

A fourth embodiment of the present disclosure will be described below with reference to FIGS. 16A to 17B.

FIG. 16A is a (first) diagram illustrating an example of a biometric information use consent information table according to the fourth embodiment.

FIG. 16B is a (second) diagram illustrating an example of the biometric information use consent information table according to the fourth embodiment.

FIG. 17A is a (first) chart illustrating a relationship between a time and permission/rejection of consent to use of a face feature for each record.

FIG. 17B is a (second) chart illustrating the relationship between a time and permission/rejection of consent to use of a face feature for each record.

In the third embodiment, priority is given to the newest record in the order of registration of the biometric information use consent information table 301, that is, an intention of consent of a biometric information provider is reflected.

In the present embodiment, for example, when a consent condition collides with a time at which use of biometric information is permitted, an intention of consent of the biometric information provider is correctly reflected.

An example in which the consent condition collides with the time will be first described with reference to FIG. 16A.

The record in the biometric information use consent information table 301 illustrated in FIG. 16A is extracted for a person for whom the value of the person ID 301b is “ID005.”

it is assumed that the magnitude relationship including times which will be described later is T1<T2<T3<ta<T4<tb<T5<T6. The left one in this relationship is defined as the earlier one.

Here, T1 to T6 are times which are designated by the consent conditions, and times ta and tb are times at which it is determined whether there is consent to use of biometric information at that time point and have a meaning of times at which acquisition or use of biometric information starts. For example, when imaging is performed at time ta, it is checked whether there is consent to imaging at the imaging time ta.

It is assumed that a person for whom the value of the person ID 301b is “ID005” is imaged and the following consent acquisition request 3 is received in S411 of FIG. 13 according to the second embodiment. Then, as a result of S412, the person for whom the value of the person ID 301b is “ID005” is left as a person candidate, and consent permission/rejection is confirmed in S421.
Consent acquisition request 3:
Person identification information:
   Face feature calculated by the feature calculating unit 22
Use situation:
   Time ta (situation)
   Face Feature (biometric Information Type)
   Acquisition and use in a device and transmission between devices (use method)

The detailed flow of S421 is the same as illustrated in FIG. 15 according to the third embodiment.

Processing of records according to a specific example of the biometric information use consent information table 301 illustrated in FIG. 16A will be described below.

First, the consent mediating unit 102 of the biometric information management server 10 extracts a record in which the value of the record number 301a is “C 0010” in S501. Then, in S504, it is determined that the conditions match on the basis of time ta of the use situation of consent acquisition request 3 and the use conditions of the record in which the record number 301a is “C0010” using Expression 1.

T1<ta<t6 . . . Expression 1

Accordingly, in S504, the consent permission/rejection of the response consent information is set to “permitted.”

After all the records have been finally processed, the consent permission/rejection of the response consent information is maintained at “permitted.”

As in the example of the biometric information use consent information table 301 illustrated in FIG. 16B, time ranges in the use situation under the use conditions for the same biometric information type “face feature” of a person with a person ID of “ID005” who provides biometric information may have an inclusion relation.

The consent permission/rejection associated with times and use of the face feature at that time is illustrated as a chart in FIG. 17A.

In this drawing, the consent permission/rejection in a certain time range for each record number is indicated by an outlined bar and a black solid bar. The outlined bar indicates that consent is permitted, and the black solid bar indicates that consent is rejected.

Rows of the record numbers “C0010” to “C0012” indicate the consent permission/rejection in the time ranges designated in each record.

For example, the row of the record number “C0010” indicates that “there is consent in a period from time T1 to time T6.” The row of C0011 indicates that there is no consent in a period from time T2 to time T5.

The row of Total indicates whether there is consent in a range from before time T1 to after time T6. In the determination of Total, similarly to the third embodiment, the record of the record number “C0010” has been registered earliest, and the record of the record number “C0012” has been registered latest. Accordingly, the order of priority is record of “C0010”<record of “C0011”<Record of “C0012.”

Similarly to the example described in the third embodiment, a result indicating that the consent permission/rejection at time ta is “permitted” can be obtained. Similarly, the consent permission/rejection at time tb is “rejected.”

Designation of time ranges does not include only a relation in which one time range is fully included in another time range. For example, in the chart illustrated in FIG. 17B, the time ranges in the records of “C0110” to “C0112” are illustrated such that one time range is not fully included in another time range and the consent permission/rejection in all the time ranges is shown in the row of Total.

Even when there are the time ranges when biometric information is used, it is possible to correctly acquire a consent state of a registered person by evaluating a plurality of pieces of consent information in the order of registration.

In the present embodiment, time ta is included in consent acquisition request 3. However, when a current time (a time at which the consent acquisition request has been transmitted, for example, which is acquired by analyzing a packet) is designated instead of time ta, time ta may not be included in the consent acquisition request.

### Fifth Embodiment

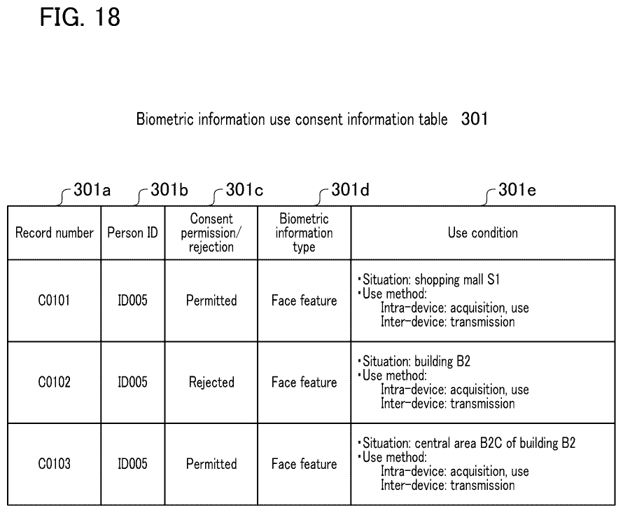

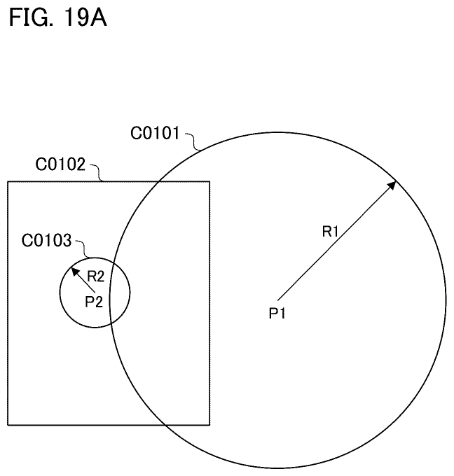

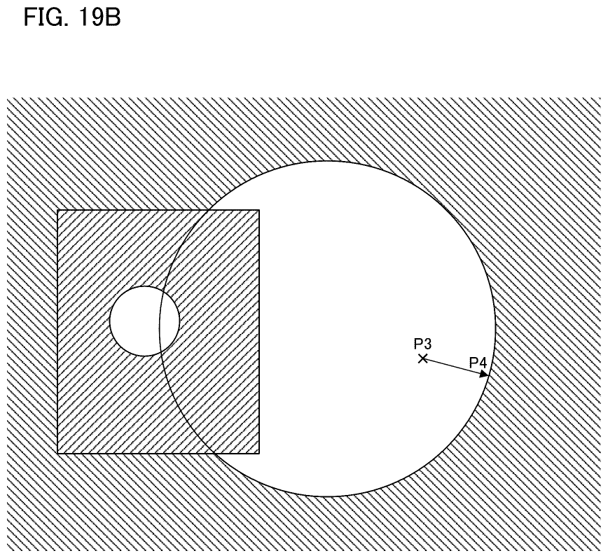

A fifth embodiment of the present disclosure will be described below with reference to FIGS. 18, 19A, and 19B.

FIG. 18 is a diagram illustrating an example of a biometric information use consent information table according to a fifth embodiment.

FIG. 19A is a (first diagram) illustrating a geographical range.

FIG. 19B is a (second diagram) illustrating a geographical range.

In the fourth embodiment, an example in which the use conditions of biometric information in the biometric information use consent information table include time ranges has been described. In the present embodiment, it is assumed that geographical valid ranges are designated in the use conditions of biometric information in the biometric information use consent information table. Designation of a geographical range is, for example, “within a radius R km from a position designated in latitude and longitude” or “within a shopping mall S1.”

In the present embodiment, it is assumed that a biometric information use consent information table 301 is registered as illustrated in FIG. 18.

FIG. 19A illustrates a geographical range of the use conditions indicated by records in which the record number 301a is “C0101” to “C0103” in FIG. 18. That is, “Situation” of the use condition 301e in the records is “shopping mall S1,” “building B2,” and “central area B2C of building B2.”

In this example, an event is held in a shopping mall S1, and a person for whom the person ID is “ID005” consents to use of biometric information in the area as indicated by the record in which the record number 301a is “C0101.” However, as indicated by the record in which the record number 301a is “C0102,” there is no consent in the building B2. As indicated by the record in which the record number 301a is “C0103,” there is consent in a predetermined central area B2C in the vicinity of the center of the building B2.

When these conditions are registered in the order of records of “C0101,” “C0102,” and “C0103,” the final consent range is a geographical range indicated by an outlined area in FIG. 19B.

In this way, even when a geographical range is designated, geographical position information may be included in the consent acquisition request. However, when a geographical position can be estimated because the biometric information management server 10 stores geographical position information of an area or the like, geographical position information may not be included in the consent acquisition request.

### Sixth Embodiment

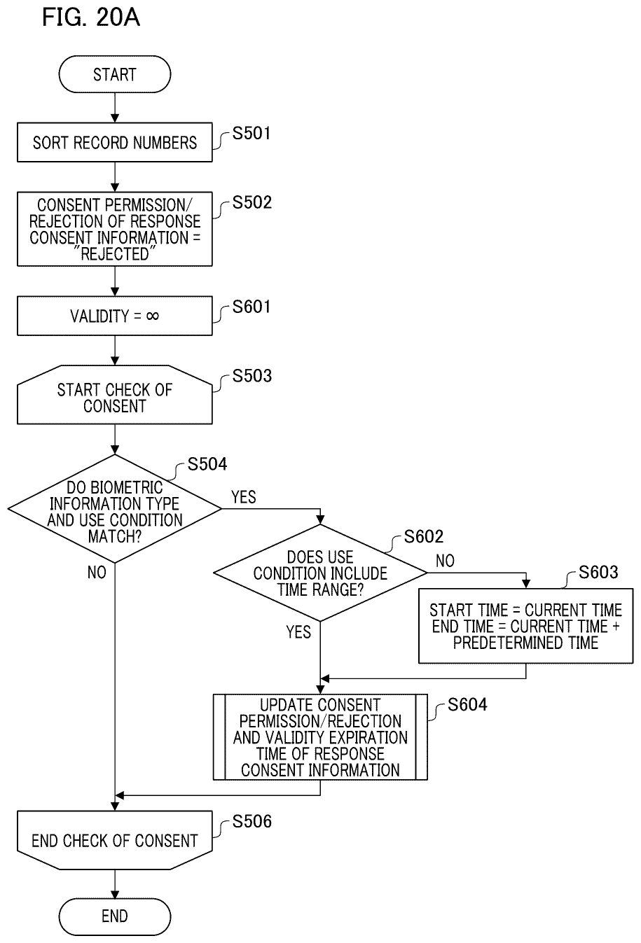

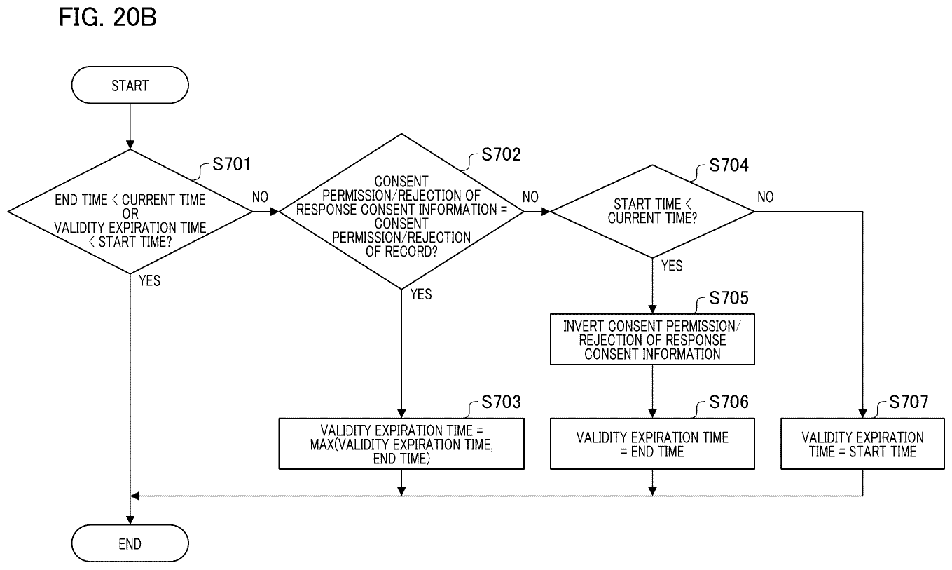

A sixth embodiment of the present disclosure will be described below with reference to FIGS. 20A to 20B.

FIG. 20A is a flowchart illustrating a process flow that is performed by a consent mediating unit according to the sixth embodiment.

FIG. 20B is a flowchart illustrating a part of the process flow that is performed by the consent mediating unit according to the sixth embodiment.

Whether there is consent is checked using a time range in the fourth embodiment and using a geographical position range in the fifth embodiment.

In the present embodiment, it is assumed that a validity expiration time (a valid range) is additionally included in response consent information.

However, whether there is consent is checked at a time point of time ta. For example, in FIG. 17A, the consent permission/rejection can be confirmed to be “permitted” at time ta. Accordingly, imaging is performed at time ta and a face feature can be calculated and used, but since it is determined that there is no consent after time T4, use of biometric information is prohibited. That is, even when it is checked whether there is consent at a certain time point, the consent is valid only at that time point, and thus it should be checked again whether there is consent after a predetermined time has elapsed.

However, communication with a server has to be performed to check whether there is consent every imaging time, and thus a communication band thereof is oppressed.

Therefore, in the present embodiment, a validity expiration time is provided in response consent information to be returned by the biometric information management server.

The process flow that is performed by the consent mediating unit when a validity expiration time is provided in response consent information to be returned by the biometric information management server will be described below with reference to FIG. 20A.

The flowchart illustrated in FIG. 20A corresponds to FIG. 15 according to the third embodiment and is different therefrom in that S601 is added and S505 is replaced with S602 to S604. Handling of the use conditions in S504 is changed. The flowchart illustrated in FIG. 20B illustrates the operations of S604 in detail.

Added and changed processes will be mainly described below.

The operation of the consent mediating unit 102 will be described below with reference to the example illustrated in FIG. 17A.

Subsequently to S502, a validity expiration time is set to “∞ (infinite)” (S601). As described above in S502, this is because consent to use of biometric information is considered as “rejected” until consent is explicitly “permitted,” and the validity expiration time is set to a default value “∞ (infinite).”

In the third embodiment, when the conditions in the consent acquisition request match the values of the biometric information type 301d and the use conditions 301e in the biometric information use consent information table 301 in S504, the consent permission/rejection of the response consent information is updated according to the value of the consent permission/rejection 301c in S505. In the present embodiment, the conditions for the time range are excluded at the time of determination of the use condition 301e in S504. Whether the conditions other than the time range match is determined in S504, and determination of the time range is performed in S602 to S604.

In S602, it is checked whether the use condition 301e includes a time range. When the use condition 301e includes a time range (S602: YES), a start time and an end time of the corresponding record correspond to the time range. For example, in a record in which the record number 301a is “C0010,” the start time is T1, and the end time is T6.

When the use condition 301e does not include a time range (S602: NO), the start time is set to a “current time,” and the end time is set to the “current time+a predetermined time” (S603). This is significant in initialization of the validity expiration time and is performed to set an appropriate validity expiration time even when the conditions do not include a time range as in the example according to the first embodiment or the second embodiment.

Inquiry occurs every imaging time when the predetermined period is set to 0, and one consent confirmation result can be continuously used without any time limit when the predetermined period is set to indefinite (infinite).

The predetermined time can be set to a value of several minutes to several tens of minutes, for example, according to characteristics of an application using biometric information.

Thereafter, the consent permission/rejection and the validity expiration time of the response consent information are updated (S604).

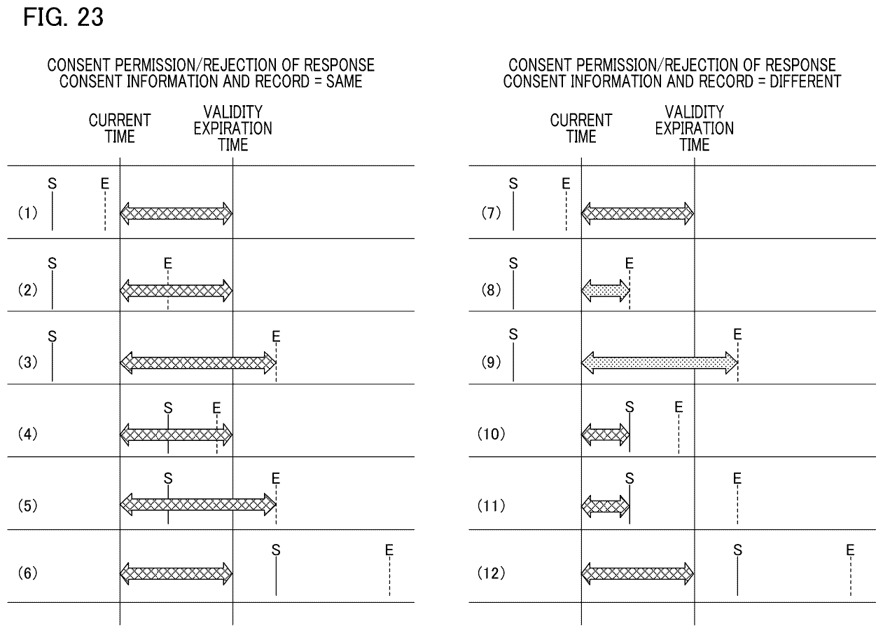

Details of the operation of S604 will be described below with reference to FIG. 20B and 23. FIG. 23 illustrates relationships between a current time, a validity expiration time, a start time, an end time, consent permission/rejection of response consent information, and consent permission/rejection of a record at the time of start of S604 and a validity expiration time and consent permission/rejection of response consent information at the time of end of S604.

S denotes a start time, E denotes an end time, and a range of a thick arrow denotes a range in which a state of the consent permission/rejection of the response consent information at the time of end of S604 is maintained. A pattern in the thick arrow indicates whether the state of the consent permission/rejection of the response consent information has changed before and after S604. A case in which the state has not changed is indicated by a hatched pattern, and a case in which the state has changed is indicated by a dot pattern.

A total of 12 cases are denoted by (1) to (12). The cases in which the values of the consent permission/rejection of the response consent information and the consent permission/rejection 301c of a record are the same at the time of start of S604 are in (1) to (6), and cases in which they are different are in (7) to (12).

For example, at the time of start of S604, the case in which the consent permission/rejection of the response consent information is “rejected,” the value of the consent permission/rejection 301c of a record is “permitted,” and start time<current time<validity expiration time<end time is satisfied corresponds to (9). In this case, at the time of end of S604, it can be seen that the consent permission/rejection of the response consent information is “permitted”, and the validity expiration time is updated with the end time.

The processes in these 12 cases are illustrated in the flowchart of FIG. 20B.

First, it is checked whether “end time<current time” or “validity expiration time<start time” is satisfied (S701). When the check result is YES, the process of S604 ends ((1), (6), (7), (12)).

When the result of S701 is NO, the consent permission/rejection of the response consent information is the same as the value of the consent permission/rejection 301c of a record (S702). When the result of S702 is YES ((2), (3), (4), (5)) and the end time exceeds the validity expiration time, the validity expiration time is updated with the end time (S703).

When the result of S702 is NO ((8), (9), (10), (11)), it is checked whether “start time<current time” is satisfied (S704). When the result of S704 is YES ((8), (9)), the consent permission/rejection of the response consent information is inverted, that is, is replaced with the value of the consent permission/rejection 301c of the record (S705). The validity expiration time is set to the end time (S706).

When the result of S704 is NO ((10), (11)), the validity expiration time is set to the start time (S707).

In the example illustrated in FIG. 17A, the value set as an initial value of the validity expiration time is “∞ (infinite)” and the consent permission/rejection of the response consent information is “rejected,” and change to “T6” and “permitted” after the record in which the record number 301a is “C0010” has been processed ((8)). The value and the consent permission/rejection change to “T5” and “rejected” after the record in which the record number 301a is “C0011” has been processed ((8)) and change to “T4” and “permitted” after the record in which the record number 301a is “C0012” has been processed ((8)). That is, the use condition of the record with the later registration time has priority.

The validity expiration time (T4) which has been set finally is included in the response consent information by the consent mediating interface unit 103 in S413 illustrated in FIG. 13 according to the second embodiment.

After the response consent information indicating “consent” has been acquired from the biometric information management server 10, the camera 20 can use biometric information (a face feature) without inquiring of the biometric information management server 10 until the validity expiration time.

In the example illustrated in FIG. 17B, with the same idea, the value set as an initial value of the validity expiration time is “∞ (infinite)” and the consent permission/rejection of the response consent information is “rejected” and change to “T4” and “permitted” after the record in which the record number 301a is “C0110” has been processed ((8)). The value and the consent permission/rejection change to “T5” and “rejected” after the record in which the record number 301a is “C0111” has been processed ((9)) and change to “T6” and “permitted” after the record in which the record number 301a is “C0112” has been processed ((9)).

By updating the validity expiration time in this way, the validity expiration time is set to the earlier time of a time point at which a predetermined time has elapsed from the current time and a time point at which the consent permission/rejection to use of biometric information changes (the end time of the time range).

It has been described above in the fifth embodiment that the geographical position information can be included in the consent conditions at the time of use of biometric information. In this case, the validity expiration time may also be set, and it is necessary to check whether the camera 20 is located in a geographical range every imaging time.

In general, measuring of a current position has a limitation that a GPS function needs to be provided in the camera 20 or has concern that power consumption in the camera 20 increases for GPS positioning in comparison with a case in which the current time is acquired.

Therefore, in many cases, a time at which the condition of the geographical range does not change may be set to a maximum value of the validity expiration time.

For example, when the predetermined time is set to 5 minutes, a moving range for 5 minutes is limited, and thus the current position may not be acquired every imaging time.

Here, the predetermined time may be set to 5 minutes in S603 of FIG. 20A.

The “time in which the condition of the geographical range is considered not to change” may be calculated on the basis of position information.

That is, a shortest time in which the condition of the geographical range does not change when a user moves from a current position at a predetermined speed can be set as the validity expiration time.

For example, when a person carrying the camera 20 moves at a predetermined speed from an x mark (position P3) in FIG. 19B according to the fifth embodiment which is a current position (the consent permission/rejection is “permitted”), a position at which the consent permission/rejection changes to “rejected” in the shortest time is P4. Therefore, when the predetermined time required for movement to P4 is defined as T7, the validity time is set to current time+T7.

Here, the predetermined speed can be set to, for example, 2 km/h when the person walks in a square. When a distance between the position P3 and the position P4 is, for example, 100 m, T7=3 minutes is obtained.

A lower limit (for example, current time+2 minutes) of the validity expiration time may be set, and the time of the lower limit may be set as the validity expiration time when the calculated validity expiration time is earlier than the lower limit.

The validity expiration time may be set to the earlier time (current time+2 minutes in this case) of the two times.

According to the present embodiment described above, an idea of the validity expiration time for use of biometric information is provided, the validity expiration time is prescribed in the use condition, and the validity expiration time in which biometric information can be used is included in the response consent information and is returned. Accordingly, it can be expected to prevent the communication band between the camera 20 and the biometric information management server 10 from being oppressed in addition to curbing an increase in power consumption of the camera 20 and reduction in an amount of calculation in the biometric information management server 10.

### Seventh Embodiment

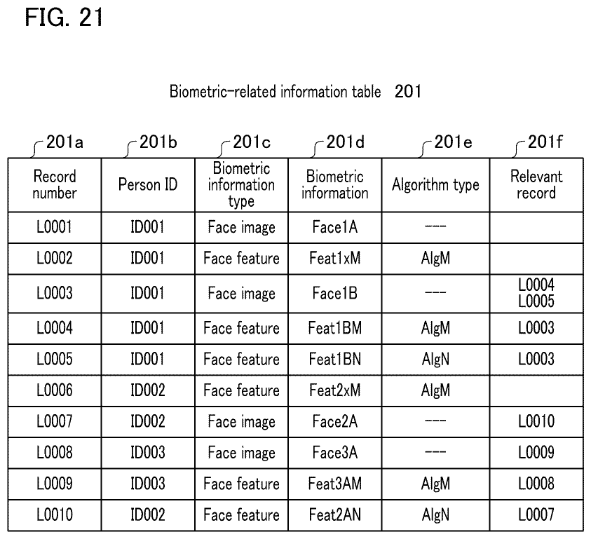

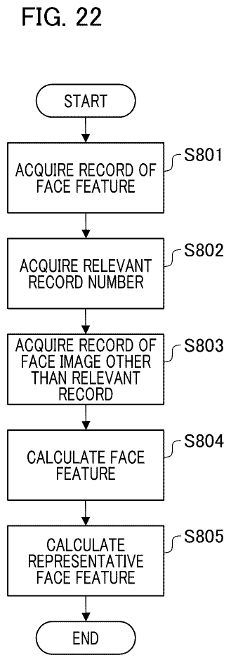

A seventh embodiment of the present disclosure will be described below with reference to FIGS. 21 to 22.

FIG. 21 is a diagram illustrating an example of a biometric-related information table according to the seventh embodiment.

FIG. 22 is a flowchart illustrating a process flow of calculating a representative feature from a plurality of features.

In the aforementioned embodiments, a face image or a face feature is stored in the biometric information management server 10, and one thereof is returned to a client (the camera 20).

In the present embodiment, an example in which a feature (a representative feature) calculated from a plurality of features is returned instead of any feature stored therein particularly when the face feature is returned will be described.

As described above, the face feature is secondary biometric information and can be calculated from a face image which is primary biometric information.

For example, it is assumed that the information managing unit 101 stores the biometric-related information table 201 as illustrated in FIG. 5. At this time, the information managing unit 101 intends to acquire a face feature (which is calculated using an algorithm type AlgM) in which the person ID 201b is “ID003” in S321 of FIG. 10.

However, in this example, regarding the person for whom the person ID 201b is “ID003,” the biometric information type 201c is “face image,” and only the biometric information 201d “Face3A” which is the face image is stored (the record number 201a “L0008”).

Therefore, the information managing unit 101 according to the present embodiment calculates a face feature Feat3AM from the face image Face3A using an algorithm of the algorithm type AlgM.

In this way, even when the face feature is not stored in the biometric information management server 10, the face feature can be returned to the camera 20 by dynamically calculating the face feature.

The calculated face feature Feat3AM may be added as a new record to the biometric-related information table 201 stored in the information managing unit 101 like a record in which the record number 201a is “L0009” in FIG. 21.

It has been described above that the face feature is secondary biometric information and can be calculated from the face image which is primary biometric information when an algorithm is designated. In view of characteristics of a face feature, a similarity between face features calculated from different face images of the same person is high.

However, when face images are different, face features are also different. A similarity between face features calculated from two face images in which a person wears glasses is generally higher than a similarity between a face feature calculated from a face image with glasses and a face feature calculated from a face image without glasses. That is, when the information managing unit 101 stores a face feature calculated from a face image without glasses, the likelihood that a face image captured in a state with glasses will be erroneously determined becomes higher.

A face feature stored in the biometric information management server 10 is not used as a feature of a “predetermined image,” but is used as a feature of a “predetermined person” (a representative face feature).

By using the representative feature, it can be expected to curb erroneous determination of a person imaged by a camera.

Therefore, when a plurality of face features are stored in the information managing unit 101, it is conceivable to calculate a face feature representative of a registered person (a representative face feature) therefrom. As a method of calculating one feature from a plurality of features, for example, a method using an arithmetic average of features (vectors) is known.

For example, when the biometric-related information table 201 illustrated in FIG. 5 is stored in the information managing unit 101, a face feature of a person for whom the person ID 201b is “ID001” using the algorithm type AlgM includes two features of Feat1xM in which the record number 201a is “L0002” and Feat1BM in which the record number 201a is “L0004.”

Therefore, the information managing unit 101 returns a representative face feature calculated from Feat1xM and Feat1BM in S431 illustrated in FIG. 13.

In general, it is thought that as many features as possible may be used as a better representative face feature. In the example illustrated in FIG. 5, the face feature calculated from the face image Face1A in which the record number 201a is “L0001” is not used to calculate the representative face feature. Therefore, it is conceivable to calculate the representative face feature from the face features including that face feature.

The process of calculating a representative face feature in S431 that is performed by the information managing unit 101 in this case will be described below with reference to FIG. 22.

First, the information managing unit 101 of the biometric information management server 10 acquires a record in which the biometric information type 201c is “face feature” (S801). That is, in the example illustrated in FIG. 5, all of the record in which the value of the person ID 201b the person ID “ID001” identified in consent information 3-1 and consent information 3-2 and the record in which the biometric information type 201c is “face feature” and the value of the algorithm type 201e is “AlgM” are acquired. The reason the value of the algorithm type 201e is “AlgM” is that the face feature is extracted in the camera 20 in S203 according to the first embodiment 203. In this example, two records in which the record number 201a is “L0002” and “L0004” can be acquired.

Then, the information managing unit 101 acquires all relevant record numbers of the values of the relevant record number 201f out of the acquired records (S802). In the example illustrated in FIG. 5, “L0003” is acquired as the value of the relevant record number 201f of the record in which the record number 201a is “L0004.”

Then, the information managing unit 101 acquires a record in which the person ID matches and the biometric information type 201c is “face image” except for the relevant record number acquired in S802 (S803). That is, all records other than the record in which value of the person ID 201b is “ID001,” the biometric information type 201c is “face image,” and the value of the record number 201a is “L0003” are acquired. In this case, a record in which the value of the record number 201a is “L0001” can be acquired.

In this case, the face feature calculated from the face image of biometric information of the record acquired in S803 using an algorithm of which the algorithm type is AlgM is not stored as biometric information in the biometric-related information table 201. Therefore, the face feature is calculated from the biometric information (the face image) of the record acquired in S803 using the algorithm of which the algorithm type is AlgM (S804).

The face feature calculated in S804 may be added and stored as a new record in the biometric-related information table 201.

Then, a representative face feature is calculated from the face feature calculated in S804 and the face feature of the record acquired in S801 (S805).

Here, for example, it is assumed that the face feature calculated in S804 is “Feat1AM.”At this time, in S805, a representative face feature is calculated from the face feature “Feat1AM” calculated in S804 and the face features “Feat1xM” and “Feat1BM” of the record acquired in S801.

In this way, it is possible to calculate a representative face feature of a person for whom the person ID is “ID001” and who is identified in consent information 3-1 and consent information 3-2.

In the present embodiment, it is possible to curb erroneous determination of a person imaged by a camera by calculating a representative face feature of a predetermined person.

### Use Condition When There is Consent to Use of Biometric Information

Use conditions when a user consents to use of biometric information will be described below.

In the aforementioned embodiments, a person for whom biometric information has been registered gives an intention of consent or non-consent to use of biometric information and can designate use conditions of the biometric information at that time.

It is significant to impose use conditions for consent to use of biometric information. Since biometric information cannot be easily changed as described above, it is necessary for a user to sufficiently understand this fact at the time of use.

As the use conditions for biometric information, a use method of biometric information, a use purpose, a use device, a use situation, an inter-person relationship, or a combination thereof can be designated.

The use method includes various methods associated with how an application uses biometric information. For example, the use method includes methods associated with acquisition such as imaging (acquisition of a face image) or calculation of a face feature (acquisition of a face feature).

The use method includes methods associated with processing of biometric information or use of biometric information such as preparation of an image in which a name is superimposed on a face image (processing) and comparison between face features (use).

The use method includes methods associated with storage of permanently storing the captured image or the calculated feature in a storage or storing the captured image or the calculated feature within a predetermined period.

The use purpose is associated with a purpose of a user when biometric information is used. Examples of the use purpose include putting a name tag on a person appearing in an image when the image is biometric information, prevention of crimes, and looking for a predetermined person (for example, looking for a lost child).

The use device is a device that is used to use biometric information. Examples of the use device include camera types such as a portable camera and a monitoring camera, a camera constituting a predetermined security system, and information for identifying a camera such as a camera manufacturing number.

The use situation is associated with in what situation biometric information is to be used. Examples of the use situation include a predetermined time range, a predetermined geographical position range, and use in a predetermined event.

The relationship between persons appearing in an acquired image is, for example, a relationship that persons appearing in an image are friends or family members when a plurality of persons appear in the same photograph.

Information such as time information when a predetermined time range is designated and position information when a predetermined geographical position range is designated is necessary for the consent acquisition request, but may be omitted when a receiver of information (the biometric information management server 10) can estimate the information.

For example, an imaging time in a camera can be estimated to be a current time, and the camera can be estimated to be in a shopping mall A when a consent acquisition request is received via a wireless LAN in the shopping mall A.

By enabling various conditions to be designated, it is possible to prevent occurrence of matter such as “consent unavoidable” or “non-consent because a predetermined situation cannot be designated” and to consent to use of biometric information under a condition of a person for whom biometric information has been registered.

According to the present disclosure, it is possible to provide a biometric information management system that can easily reflect an intention of consent to use of biometric information of a person for whom biometric information has been registered and maintain consistency of consent to use of biometric information under various conditions.

While embodiments have been described above in detail, the present disclosure can be realized as embodiments such as a system, a device, a method, a program, and a recording medium (a storage medium). Specifically, the present disclosure may be applied to a system including a plurality of devices (for example, a host computer, an interface device, an imaging device, and a web application) or may be applied to a device constituted by a single device.

In order to realize the present disclosure, a computer-readable recording medium (or a storage medium) storing software program codes (computer programs) for realizing the functions of the embodiments is supplied to a system or a device. Then, a computer (or a CPU or an MPU) of the system or the device reads and executes the program codes stored in the storage medium. In this case, the program codes read from the storage medium realize the functions of the embodiments, and the recording medium storing the program codes serve as constituents for carrying out the present disclosure.

Embodiments of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiments and/or that includes one or more circuits (e.g., application specific integrated circuit (ASIC)) for performing the functions of one or more of the above-described embodiments, and by a method performed by the computer of the system or apparatus by, for example, reading out and executing the computer executable instructions from the storage medium to perform the functions of one or more of the above-described embodiments and/or controlling the one or more circuits to perform the functions of one or more of the above-described embodiments. The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-012465, filed Jan. 28, 2025, which is hereby incorporated by reference herein in its entirety.

What is claimed is:

1. A biometric information management device storing biometric-related information and managing availability of the biometric information, the biometric information management device comprising:
at least one memory storing instructions; and
at least one processor executing the stored instructions causing the biometric information management device to perform:
acquiring consent information allowing use of the biometric information received from an external device;
storing and managing, in the at least one memory, the biometric-related information and the consent information;
generating, based on a consent acquisition request for use of designated biometric information from the external device, and the stored consent information, a consent information response indicating the availability of the biometric information; and
returning the consent information response on the basis of the consent acquisition request to the external device which transmitted the consent acquisition request.

2. The biometric information management device according to claim 1, wherein the biometric-related information includes:
biometric information which is information originating from an organism;
a biometric information type indicating a type of the biometric information; and
a biometric information calculation algorithm type that identifies a predetermined algorithm used when the biometric information is secondary biometric information derived from primary biometric information directly acquired from the organism using the predetermined algorithm.

3. The biometric information management device according to claim 1, wherein the consent information includes:
a type of biometric information for which is a target of consent or non-consent is provided;
a biometric information use condition indicating a condition for using biometric information; and
consent type information indicating whether to consent to use the type of the biometric information when the biometric information use condition is satisfied or not to consent to use the type of the biometric information when the biometric information use condition is satisfied.

4. The biometric information management device according to claim 1, wherein the consent acquisition request includes person identification information for uniquely identifying a registered person or person identification auxiliary information for listing candidates for the registered person in the biometric information management device, and
wherein the consent information response includes information indicating whether consent to use the biometric information is permission or rejected.

5. The biometric information management device according to claim 2, wherein the consent acquisition request further includes the biometric information calculation algorithm type for identifying an algorithm deriving secondary biometric information from primary biometric information when the biometric information type is the secondary biometric information derived from the primary biometric information, and
wherein the response consent information further includes biometric information when the consent permission/rejection indicates permission.

6. The biometric information management device according to claim 4, wherein the consent acquisition request further includes:
position information of a device that acquires or uses the biometric information;
a time at which acquisition or use of the biometric information starts;
information for identifying the device that acquires or uses the biometric information; and
one of situations in which the biometric information is acquired or used.

7. The biometric information management device according to claim 1, wherein the executing the stored instructions by the processor further causes the biometric information management device to perform:
evaluating pieces of consent information regarding a person for whom the same biometric information has been registered from the piece of consent information in which a registration time is the latest.

8. The biometric information management device according to claim 7, wherein the executing the stored instructions by the processor further causes the biometric information management device to perform:
validating the piece of consent information in which the registration time is the latest out of the plurality of pieces of consent information for the person for whom the same biometric information has been registered satisfying the same biometric information use condition.

9. The biometric information management device according to claim 4, wherein the response consent information further includes one of a validity expiration time of the response consent information and a geographic validity range in which the biological information is able to be handled when the consent permission/rejection indicates permission.

10. The biometric information management device according to claim 9, wherein the validity expiration time is a time point at which a predetermined time has elapsed from a time at which acquisition or use of the biometric information has started.

11. The biometric information management device according to claim 9, wherein the validity expiration time is an earlier time point of a next time of change of the consent permission/rejection at the time of the start of acquisition or use of biometric information and a time point at which a predetermined time has elapsed from a start time.

12. The biometric information management device according to claim 9, wherein the validity expiration time is one of an earliest time point at which the consent permission/rejection at a position of a device that acquires or uses the biometric information next changes and a time point at which a predetermined time has elapsed from a time at which acquisition or use of the biometric information has started.

13. The biometric information management device according to claim 5, wherein the executing the stored instructions by the processor further causes the biometric information management device to perform:
dynamically generating secondary biometric information from the biometric information, when the biometric information to be included in the response consent information is not stored and the secondary biometric information is stored.

14. The biometric information management device according to claim 1, wherein the biometric information is one of a face image and a face feature vector which is derived from the face image using a predetermined algorithm.

15. The biometric information management device according to claim 14, wherein the executing the stored instructions by the processor further causes the biometric information management device to perform:
generating one representative feature from a plurality of face feature vectors when the plurality of face feature vectors of the same person have been registered, and setting the representative feature as a face feature vector of the person.

16. The biometric information management device according to claim 3, wherein the biometric information use condition is one of
a use method including one or more of acquisition, use, and storage,
a use purpose including one or more of putting a name tag on a person appearing in an image, prevention of crimes, and looking for a predetermined person,
a use device including one or more of a predetermined camera and a predetermined security system,
a use situation including one or more of a predetermined time range, a predetermined geographical range, and use in a predetermined event,
a relationship between persons for prescribing a relationship persons appearing in an image have, or
any combination thereof.

17. A biometric information management system storing biometric-related information and managing availability of the biometric information, the biometric information management system comprising:
a biometric information management server;
an external device that is connected to the biometric information management server via a network and uses the biometric information; and
a consent information registration client that is connected to the biometric information management server via the network and registers consent information,
wherein the biometric information management server includes:
at least one memory storing instructions; and
at least one processor executing the stored instructions causing the biometric information management server to perform:
acquiring the consent information allowing use of the biometric information received from the external device;
storing and managing, in the at least one memory, the biometric-related information and the consent information;
generating, based on a consent acquisition request for use of designated biometric information from the external device, and the stored consent information, a consent information response indicating the availability of the biometric information; and
returning the consent information response on the basis of the consent acquisition request to the external device which transmitted the consent acquisition request.

18. A biometric information management method that is performed by a biometric information management system storing biometric-related information and managing availability of the biometric information, the biometric information management system including:
a biometric information management server;
an external device that is connected to the biometric information management server via a network and uses the biometric information; and
a consent information registration client that is connected to the biometric information management server via the network and registers consent information,
the method comprising:
causing the consent information registration client to register the consent information in the biometric information management server;
causing the biometric information management server to acquire the consent information allowing use of the biometric information received from the external device;
causing the biometric information management server to store and manage, in the at least one memory, the biometric-related information and the consent information;
causing the external device using the biometric information to transmit a consent acquisition request for use of designated biometric information to the biometric information management server;
causing the biometric information management server to generate, based on the consent acquisition request for use of the designated biometric information from the external device using the biometric information, and the stored consent information, a consent information response indicating the availability of the biometric information; and
causing the biometric information server to return the consent information response on the basis of the consent acquisition request to the external device which transmitted the consent acquisition request.

19. A non-transitory storage medium storing a program of a biometric information management system, the program causing a computer to perform each step of a biometric information management method of storing biometric-related information and managing availability of the biometric information, the biometric information management system including:
a biometric information management server;
an external device that is connected to the biometric information management server via a network and uses the biometric information; and
a consent information registration client that is connected to the biometric information management server via the network and registers consent information,
the method comprising:
causing the consent information registration client to register the consent information in the biometric information management server;
causing the biometric information management server to acquire the consent information allowing use of the biometric information received from the external device;
causing the biometric information management server to store and manage, in the at least one memory, the biometric-related information and the consent information;
causing the external device using the biometric information to transmit a consent acquisition request for use of designated biometric information to the biometric information management server;
causing the biometric information management server to generate, based on the consent acquisition request for use of the designated biometric information from the external device using the biometric information, and the stored consent information, a consent information response indicating the availability of the biometric information; and
causing the biometric information server to return the consent information response on the basis of the consent acquisition request to the external device which transmitted the consent acquisition request.
